(19) United States
(12) Patent Application Publication
(10) Pub. No.: US 2025/0140198 A1
(43) Pub. Date: May 1, 2025

(54) DRIVER AND DISPLAY DEVICE

(71) Applicant: Samsung Display Co., Ltd., Yongin-Si (KR)

(72) Inventors: JUNGHWAN HWANG, Yongin-si (KR); DONGWOO KIM, Yongin-si (KR); JIHOON YANG, Yongin-si (KR); HYUNJOON KIM, Yongin-si (KR)

(21) Appl. No.: 18/919,448

(22) Filed: Oct. 18, 2024

(30) Foreign Application Priority Data
Oct. 25, 2023 (KR) 10-2023-0144159

(51) Int. Cl. G09G 3/3258

(52) U.S. Cl. CPC G09G 3/3258; G09G 2300/0876; G09G 2310/0286; G09G 2310/0289; G09G 2310/08

(57) ABSTRACT

A driver including multiple stages is disclosed. At least one of the stages includes an input circuit configured to transfer an input signal to a first node in response to a clock signal, a first transistor connected between the first node and a second node, a carry circuit configured to output a carry signal having a first high gate voltage when the second node has the first high gate voltage, and a level shifting output circuit configured to output an output signal having a second high gate voltage higher than the first high gate voltage by level-shifting the first high gate voltage of the second node.

### CROSS-REFERENCE TO RELATED APPLICATION(S)

This application claims priority under 35 U.S.C. § 119 to Korean Patent Application No. 10-2023-0144159, filed on Oct. 25, 2023 in the Korean Intellectual Property Office (KIPO), the disclosure of which is herein incorporated by reference in its entirety.

### BACKGROUND

### 1. Field

The present disclosure relates to display devices and more particularly to embodiments of a driver providing signals to pixels of a display device and of the display device including the driver.

### 2. Description of the Related Art

A driver (e.g., a gate driver and/or an emission driver) of a display device may sequentially provide signals (e.g., gate signals and/or emission signals) to pixels of a display panel on a row-by-row basis. To sequentially provide the signals on the row-by-row basis, the driver may be implemented in the form of a shift register including a plurality of stages.

In general, the driver may operate based on a clock signal that toggles between a high gate voltage and a low gate voltage. Further, the high gate voltage of the clock signal may have a voltage level that is substantially the same as a voltage level of a high gate voltage of an output signal of the driver.

### SUMMARY

Some embodiments disclosed herein provide a driver capable of reducing power consumption.

Some embodiments disclosed herein provide a display device including a driver capable of reducing power consumption.

According to an embodiment, a driver may include a plurality of stages. At least one stage of the plurality of stages includes an input circuit configured to transfer an input signal to a first node in response to a clock signal, a first transistor connected between the first node and a second node, a carry circuit configured to output a carry signal having a first high gate voltage when the second node has the first high gate voltage, and a level shifting output circuit configured to output an output signal having a second high gate voltage higher than the first high gate voltage by level-shifting the first high gate voltage of the second node.

In an embodiment, the clock signal may toggle between a low gate voltage and the first high gate voltage.

In an embodiment, the level shifting output circuit may include at least one p-type metal-oxide-semiconductor (PMOS) transistor and at least one n-type metal-oxide-semiconductor (NMOS) transistor, and a first active region of the PMOS transistor may include a material different from a material of a second active region of the NMOS transistor.

In an embodiment, the level shifting output circuit may further include at least one capacitor connected between a gate of the PMOS transistor and a gate of the NMOS transistor.

In an embodiment, the first transistor may include a gate receiving a low gate voltage, a first terminal connected to the first node, and a second terminal connected to the second node.

In an embodiment, the input circuit may include a second transistor including a gate receiving the clock signal, a first terminal receiving the input signal, and a second terminal connected to the first node.

In an embodiment, the input circuit may further include a third transistor including a gate receiving an inverted clock signal, a first terminal receiving the input signal, and a second terminal connected to the first node.

In an embodiment, the second transistor may be a PMOS transistor, and the third transistor may be an NMOS transistor.

In an embodiment, the carry circuit may include a fourth transistor including a gate connected to a third node, a first terminal receiving the first high gate voltage, and a second terminal connected to a carry node at which the carry signal is output, and a fifth transistor including a gate connected to the second node, a first terminal connected to the carry node, and a second terminal receiving a low gate voltage.

In an embodiment, the carry circuit may further include a first capacitor including a first electrode connected to the carry node, and a second electrode connected to the second node.

In an embodiment, the level shifting output circuit may include a sixth transistor including a gate connected to a fourth node, a first terminal receiving the second high gate voltage, and a second terminal connected to a third node, a seventh transistor including a gate connected to the second node, a first terminal connected to the third node, and a second terminal receiving a low gate voltage, an eighth transistor including a gate connected to the third node, a first terminal receiving the second high gate voltage, and a second terminal connected to the fourth node, a ninth transistor including a gate connected to the second node, a first terminal connected to the fourth node, and a second terminal receiving the low gate voltage, and a second capacitor including a first electrode connected to the fourth node, and a second electrode connected to the second node.

In an embodiment, the sixth, eighth, and ninth transistors may be PMOS transistors, and the seventh transistor may be an NMOS transistor.

In an embodiment, the seventh transistor may further include a bottom gate, and the bottom gate may receive a bias voltage.

In an embodiment, the fourth node may be an output node at which the output signal is output.

In an embodiment, the level shifting output circuit may further include a tenth transistor including a gate connected to the third node, a first terminal receiving the second high gate voltage, and a second terminal connected to an output node at which the output signal is output, an eleventh transistor including a gate connected to the second node, a first terminal connected to the output node, and a second terminal receiving the low gate voltage, and a third capacitor including a first electrode connected to the output node, and a second electrode connected to the second node.

In an embodiment, the level shifting output circuit may include a sixth transistor including a gate connected to a fourth node, a first terminal receiving the second high gate voltage, and a second terminal connected to a third node, a seventh transistor including a gate connected to the second node, a first terminal connected to the third node, and a second terminal receiving a low gate voltage, an eighth transistor including a gate connected to the third node, a first terminal receiving the second high gate voltage, and a second terminal connected to the fourth node, a ninth transistor including a gate connected to the third node, a first terminal connected to the fourth node, and a second terminal receiving the low gate voltage, and a second capacitor including a first electrode connected to the fourth node, and a second electrode connected to the second node.

In an embodiment, the level shifting output circuit may further include a tenth transistor including a gate connected to the third node, a first terminal receiving the second high gate voltage, and a second terminal connected to an output node at which the output signal is output, an eleventh transistor including a gate connected to the third node, a first terminal connected to the output node, and a second terminal receiving the low gate voltage, and a third capacitor including a first electrode connected to the output node, and a second electrode connected to the second node.

In an embodiment, the sixth, eighth and tenth transistors may be PMOS transistors, and the seventh, ninth, and eleventh transistors may be NMOS transistors.

In an embodiment, each of the ninth and eleventh transistors may further include a bottom gate, and the bottom gate may receive the low gate voltage.

In an embodiment, the at least one stage may further include a second transistor connected in series with the first transistor between the first node and the second node, and the first and second transistors may be different types of transistors.

In an embodiment, a second low gate voltage of the output signal may be lower than a first low gate voltage of the input signal, the clock signal, and the carry signal.

According to an embodiment, a driver may include a plurality of stages. At least one stage of the plurality of stages includes an input circuit configured to transfer an input signal to a first node in response to a clock signal, a first transistor connected between the first node and a second node, a carry circuit configured to output a carry signal having a first high gate voltage when the second node has the first high gate voltage, a level shifter circuit configured to level-shift the first high gate voltage of the second node such that a third node has a second high gate voltage higher than the first high gate voltage, a second transistor connected between the third node and a fourth node, and configured to transfer the second high gate voltage of the third node to the fourth node, and a level-shifting output circuit configured to output an output signal having a third high gate voltage higher than the second high gate voltage by level-shifting the second high gate voltage of the fourth node.

In an embodiment, the at least one stage may further include a third transistor connected in series with the first transistor between the first node and the second node, and a fourth transistor connected in series with the second transistor between the third node and the fourth node. The first and third transistors may be different types of transistors, and the second and fourth transistors may be different types of transistors.

In an embodiment, a second low gate voltage of the third node may be lower than a first low gate voltage of the input signal, the clock signal and the carry signal, and a third low gate voltage of the output signal may be lower than the second low gate voltage of the third node.

According to an embodiment, a display device may include a display panel including a plurality of pixels, a data driver configured to provide data signals to the plurality of pixels, a gate driver configured to provide gate signals to the plurality of pixels, an emission driver configured to provide emission signals to the plurality of pixels, and a controller configured to control the data driver, the gate driver, and the emission driver. At least one of the gate driver and the emission driver includes a plurality of stages. At least one stage of the plurality of stages includes an input circuit configured to transfer an input signal to a first node in response to a clock signal, a first transistor connected between the first node and a second node, a carry circuit configured to output a carry signal having a first high gate voltage when the second node has the first high gate voltage, and a level shifting output circuit configured to output an output signal having a second high gate voltage higher than the first high gate voltage by level-shifting the first high gate voltage of the second node.

As described above, in a driver and a display device, at least one stage may include a level shifting output circuit, and the level shifting output circuit may output an output signal having a second high gate voltage higher than a first high gate voltage by level-shifting the first high gate voltage of an internal node of the stage. Accordingly, the first high gate voltage of a signal applied to the stage and the first high gate voltage of the internal node of the stage may be lower than the second high gate voltage of the output signal, and thus power consumption of the driver and the display device may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an embodiment of a driver.

FIG. 2 is a timing diagram for describing an example of an operation of a driver of FIG. 1.

FIG. 3 is a block diagram illustrating a stage of a driver according to an embodiment of the present disclosure.

FIG. 4 shows a table illustrating an example of power consumption of a driver according to voltage levels of a first high gate voltage.

FIG. 5 shows a cross-section of an example of a PMOS transistor and an NMOS transistor included in a stage of FIG. 3.

FIG. 6 is a circuit diagram for an embodiment of a stage of a driver.

FIG. 7 is a timing diagram for describing an example of an operation of the stage of FIG. 6.

FIG. 8 is a circuit diagram illustrating an example of an operation of the stage of FIG. 6 during a first time period.

FIG. 9 shows graphs illustrating an example of signal voltages at nodes in the stage of FIG. 6 during an initial portion of a first time period.

FIG. 10 is a circuit diagram illustrating an example of an operation of the stage of

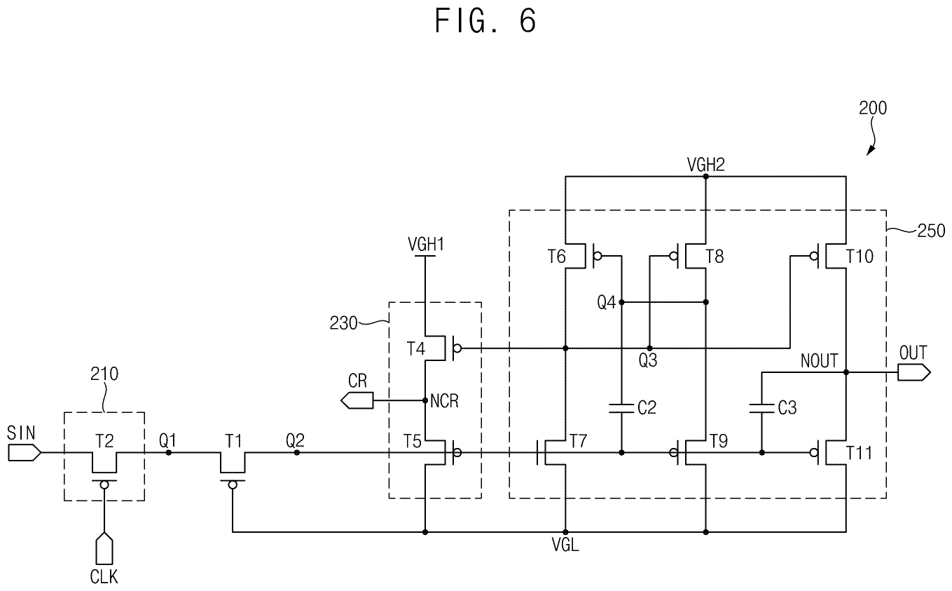

FIG. 6 during a second time period.

FIG. 11 is a circuit diagram illustrating a stage of a driver according to an embodiment.

FIG. 12 is a circuit diagram illustrating a stage of a driver according to an embodiment.

FIG. 13 is a circuit diagram illustrating a stage of a driver according to an embodiment.

FIG. 14 is a circuit diagram illustrating a stage of a driver according to an embodiment.

FIG. 15 is a circuit diagram illustrating a stage of a driver according to an embodiment.

FIG. 16 is a circuit diagram illustrating a stage of a driver according to an embodiment.

FIG. 17 is a circuit diagram illustrating a stage of a driver according to an embodiment.

FIG. 18 is a circuit diagram illustrating a stage of a driver according to an embodiment.

FIG. 19 is a block diagram illustrating a stage of a driver according to an embodiment.

FIG. 20 is a circuit diagram illustrating a stage of a driver according to an embodiment.

FIG. 21 is a block diagram illustrating a stage of a driver according to an embodiment.

FIG. 22 is a circuit diagram illustrating a stage of a driver according to an embodiment.

FIG. 23 is a block diagram illustrating a stage of a driver according to an embodiment.

FIG. 24 is a circuit diagram illustrating a stage of a driver according to an embodiment.

FIG. 25 is a block diagram illustrating a display device according to an embodiment.

FIG. 26 is a block diagram illustrating an electronic device including a display device according to an embodiment.

### DETAILED DESCRIPTION OF EMBODIMENTS

The example embodiments are described more fully hereinafter with reference to the accompanying drawings. Like or similar reference numerals refer to like or similar elements throughout.

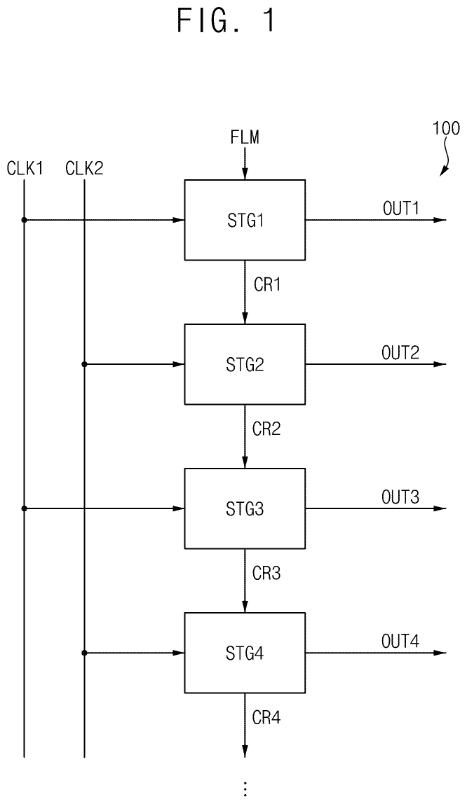

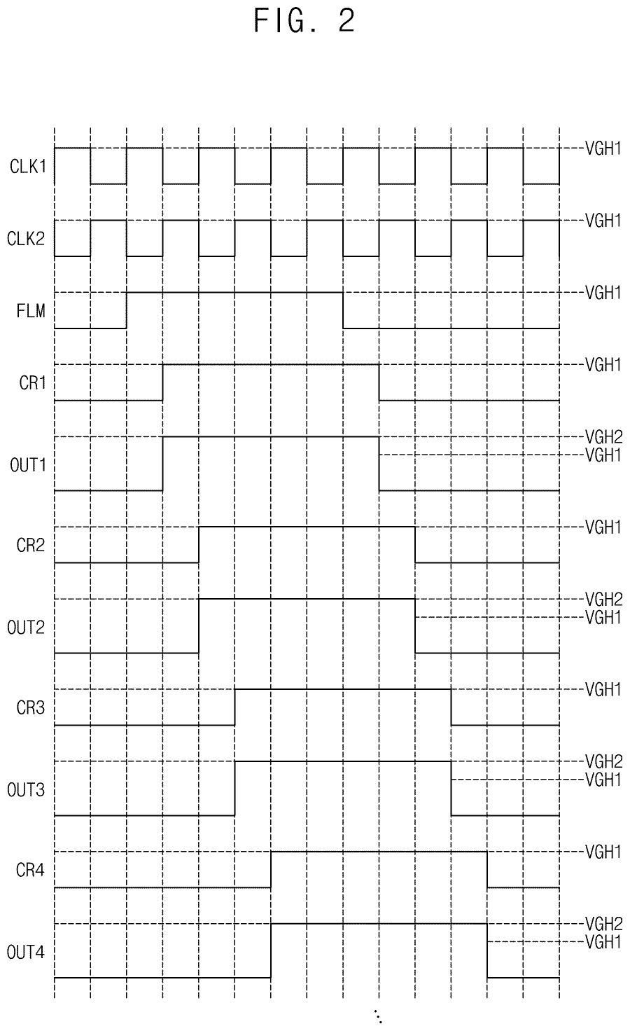

FIG. 1 is a block diagram illustrating a driver according to an embodiment, and FIG. 2 is a timing diagram illustrating an example of an operation of the driver of FIG. 1.

Referring to FIG. 1, a driver 100 according to the illustrated embodiment may include a plurality of stages STG1, STG2, STG3, STG4, . . . . The driver 100 may be implemented in the form of a shift register in which the plurality of stages STG1, STG2, STG3, STG4, . . . sequentially output output signals OUT1, OUT2, OUT3, OUT4, . . . of the driver 100. In some embodiments, the driver 100 may be included in a display device and may be formed in a display panel of the display device. For example, the driver 100 may be integrated or formed on a substrate of the display panel.

Based on a start signal FLM, a first clock signal CLK1, and a second clock signal CLK2 input to the driver 100, the plurality of stages STG1, STG2, STG3, STG4, . . . may sequentially generate carry signals CR1, CR2, CR3, CR4, . . . and may sequentially output the output signals OUT1, OUT2, OUT3, OUT4, . . . , e.g., to a plurality of pixels of the display panel. In some embodiments, the first clock signal CLK1 and the second clock signal CLK2 may have the same frequency but different phases. For example, the first clock signal CLK1 and the second clock signal CLK2 may have opposite phases, e.g., be 180° out of phase. Further, a first stage STG1 may receive the start signal FLM as an input signal, and each of subsequent stages STG2, STG3, STG4, . . . may receive a carry signal CR1, CR2, CR3, . . . from a previous stage as the input signal. For example, a second stage STG2 may receive a first carry signal CR1 from the first stage STG1 as an input signal, a third stage STG3 may receive a second carry signal CR2 from the second stage STG2 as an input signal, and a fourth stage STG4 may receive a third carry signal CR3 of the third stage STG3 as an input signal.

In some embodiments, odd-numbered stages STG1, STG3, . . . may respectively output the odd-numbered output signals OUT1, OUT3, . . . in response to the first clock signal CLK1, and even-numbered stages STG2, STG4, . . . may respectively output the even-numbered output signals OUT2, OUT4, . . . in response to the second clock signal CLK2. For example, as illustrated in FIGS. 1 and 2, when the first clock signal CLK1 transitions to a low level after the start signal FLM transitions to a high level, the first stage STG1 may generate a first carry signal CR1 and a first output signal OUT1 having the high level. Further, when the first clock signal CLK1 transitions to the low level after the start signal FLM transitions to the low level, the first stage STG1 may change the first carry signal CR1 and the first output signal OUT1 to the low level. When the second clock signal CLK2 transitions to the low level after the first carry signal CR1 changes to the high level, the second stage STG2 may generate a second carry signal CR2 and a second output signal OUT2 having the high level. Further, when the second clock signal CLK2 transitions to the low level after the first carry signal CR1 changes to the low level, the second stage STG2 may change the second carry signal CR2 and the second output signal OUT2 to the low level. When the first clock signal CLK1 transitions to the low level after the second carry signal CR2 changes to the high level, the third stage STG3 may generate a third carry signal CR3 and a third output signal OUT3 having the high level. Further, when the first clock signal CLK1 transitions to the low level after the second carry signal CR2 changes the low level, the third stage STG3 may change the third carry signal CR3 and the third output signal OUT3 to the low level. When the second clock signal CLK2 transitions to the low level after the third carry signal CR3 changes to the high level, the fourth stage STG4 may generate a fourth carry signal CR4 and a fourth output signal OUT4 having the high level. Further, when the second clock signal CLK2 transitions to the low level after the third carry signal CR3 changes to the low level, the fourth stage STG4 may change the fourth carry signal CR4 and the fourth output signal OUT4 to the low level. In this manner, the plurality of stages STG1, STG2, STG3, STG4, . . . may sequentially output the output signals OUT1, OUT2, OUT3, OUT4, . . . by delaying or shifting the output signals OUT1, OUT2, OUT3, OUT4, . . . by half a period of each clock signal CLK1 and CLK2.

In the driver 100 according to an embodiment, each stage STG1, STG2, STG3, STG4, . . . may output the output signal OUT1, OUT2, OUT3, OUT4, . . . having a second high gate voltage VGH2 higher than a first high gate voltage VGH1 by level-shifting the first high gate voltage VGH1. Thus, although the output signals OUT1, OUT2, OUT3, OUT4, . . . output from each stage STG1, STG2, STG3, STG4, . . . to the plurality of pixels have the second high gate voltage VGH2 as a high voltage, signals applied to each stage STG1, STG2, STG3, STG4, . . . , or the first clock signal CLK1, the second clock signal CLK2, a high voltage of the start signal FLM and the carry signals CR1, CR2, CR3, CR4, . . . may be the first high gate voltage VGH1, which may be lower than the second high gate voltage VGH2. Accordingly, since the driver 100 operates based on the first high gate voltage VGH1 lower than the second high gate voltage VGH2, power consumption of the driver 100 according to an embodiment may be reduced.

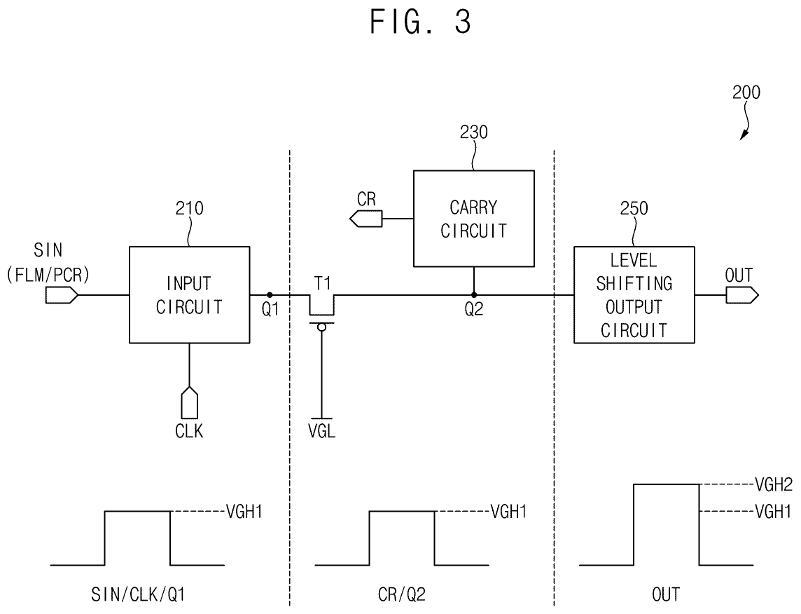

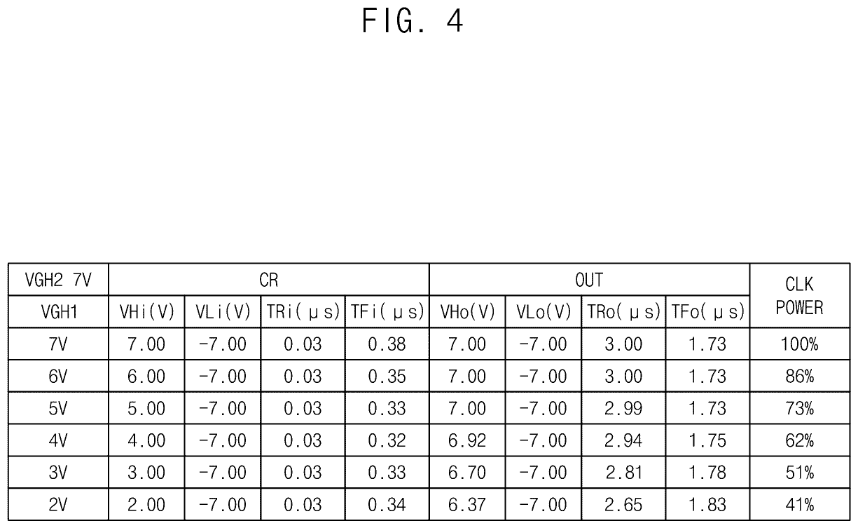

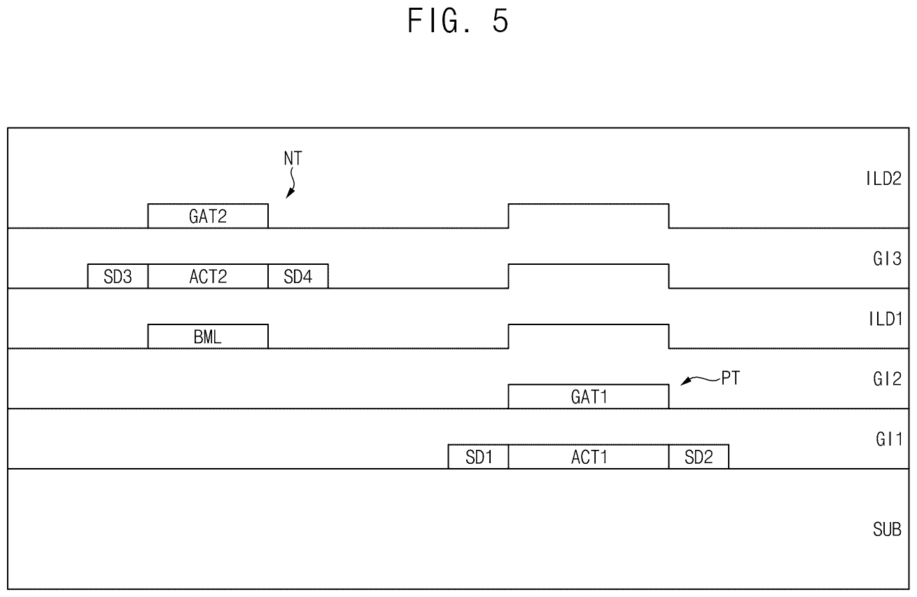

FIG. 3 is a block diagram illustrating a stage of a driver according to an embodiment, FIG. 4 is a table illustrating an example of power consumption of a driver according to voltage levels of a first high gate voltage, and FIG. 5 is a cross-sectional diagram illustrating an example of a PMOS transistor and an NMOS transistor included in a stage of FIG. 3.

Referring to FIG. 3, each stage 200, e.g., each of stages STG1, STG2, STG3, . . . , of a driver according to the illustrated embodiment may include an input circuit 210, a first transistor T1, a carry circuit 230, and a level shifting output circuit 250.

The input circuit 210 may transfer an input signal SIN to a first node Q1 in response to a clock signal CLK. In some embodiments, the input circuit 210 of a first stage among a plurality of stages of the driver may receive a start signal FLM as the input signal SIN, and each of subsequent stages may receive a carry signal PCR of a previous stage as the input signal SIN. In some embodiments, the clock signal CLK may periodically toggle between a low gate voltage VGL and a first high gate voltage VGH1. Further, in some embodiments, the input circuit 210 of an odd-numbered stage may receive a first clock signal CLK1 illustrated in FIGS. 1 and 2 as the clock signal CLK, and the input circuit 210 of an even-numbered stage may receive a second clock signal CLK2 illustrated in FIGS. 1 and 2 as the clock signal CLK.

The first transistor T1 may be connected between the first node Q1 and a second node Q2. The first transistor T1 may be a PMOS transistor having a gate of the first transistor T1 connected to a line for transferring the low gate voltage VGL, and the first transistor T1 may be referred to as an always-on transistor (AOT). In some embodiment, the first transistor T1 may include a gate for receiving the low gate voltage VGL, a first terminal connected to the first node Q1, and a second terminal connected to the second node Q2.

The carry circuit 230 may be connected to the second node Q2. The carry circuit 230 may output a carry signal CR having the first high gate voltage VGH1 when the second node Q2 has the first high gate voltage VGH1. The carry signal CR of the carry circuit 230 may be provided to a next stage as the input signal SIN for the next stage.

The level shifting output circuit 250 may output an output signal OUT having a second high gate voltage VGH2 higher than the first high gate voltage VGH1 by level-shifting the first high gate voltage VGH1 of the second node Q2. That is, as illustrated in FIG. 3, the input signal SIN and the clock signal CLK, which are applied to the input circuit 210, and the first node Q1, which is connected to the input circuit 210, may have the first high gate voltage VGH1 as a high voltage. Further, the carry signal CR output from the carry circuit 230, and the second node Q2 connected to the carry circuit 230 may have the first high gate voltage VGH1 as a high voltage. However, the output signal OUT output from the level shifting output circuit 250 may have as a high voltage the second high gate voltage VGH2, which is higher than the first high gate voltage VGH1. Accordingly, a high voltage (i.e., the first high gate voltage VGH1) of signals (e.g., the input signal SIN and the clock signal CLK) applied to the stage 200 and internal nodes (e.g., the first node Q1 and the second node Q2) of the stage 200 may be lower than a high voltage (i.e., the second high gate voltage VGH2) required by pixels to which the output signal OUT is applied. Accordingly, power consumption of the driver including the stage 200 may be reduced.

FIG. 4 illustrates an example where the low gate voltage VGL is about −7V, and a high voltage required by the pixels or the second high gate voltage VGH2 is about 7V. In different cases corresponding to different rows shown in FIG. 4, the first high gate voltage VGH1 that is a high voltage VHi of the carry signal CR, the input signal SIN, the clock signal CLK, the first node Q1 and the second node Q2 may be about 7V, about 6V, about 5V, about 4V, about 3V, or about 2V, but a high voltage VHo of the output signal OUT may remain about 7V. A low voltage VLi of the carry signal CR and the output signal OUT may be about −7V for all cases. Further, as illustrated in FIG. 4, even if the first high gate voltage VGH1 decreases, a rising time TRi and a falling time TFi of the carry signal CR and a rising time TRO and a falling time TFo of the output signal OUT may not be substantially increased. If the first high gate voltage VGH1 decreases from about 7V of the second high gate voltage VGH2 to about 6V, about 5V, about 4V, about 3V, and about 2V, power consumption of the driver caused by the clock signal CLK may be reduced by about 86%, about 73%, about 62%, about 51%, and about 41%, respectively. That is, in the driver according to embodiments, signals CR, SIN, and CLK and nodes Q1 and Q2 may have the first high gate voltage VGH1 as their high voltage VHi, and the first high gate voltage VGH1 being lower than the second high gate voltage VGH2 causes the power consumption of the driver to be reduced while the driver provides the output signal OUT with its normal or desired voltage and timing characteristics.

In some embodiments, the stage 200 or the level shifting output circuit 250 may include at least one p-type metal-oxide-semiconductor (PMOS) transistor and at least one n-type metal-oxide-semiconductor (NMOS) transistor. Further, in some embodiments, a first active region of the PMOS transistor and a second active region of the NMOS transistor may be formed of different materials. That is, the first active region of the PMOS transistor may include a material different from a material of the second active region of the NMOS transistor. Further, in some embodiments, the NMOS transistor may include a gate (e.g., a top gate) located above the second active region and a bottom gate located below the second active region.

For example, as illustrated in FIG. 5, a first source/drain region SD1, the first active region ACT1 and a second source/drain region SD2 of the PMOS transistor PT may be formed on a substrate SUB of a display panel. In some embodiments, a buffer layer may be further formed between the substrate SUB and the first active region ACT1 to prevent permeation of impurities into the first active region ACT1, but embodiments are not limited thereto. The first active region ACT1 of the PMOS transistor PT may include polycrystalline silicon, for example, low temperature polycrystalline silicon (LTPS). Further, the first and second source/drain regions SD1 and SD2 may be p+ doped regions and may respectively serve as a source and a drain of the PMOS transistor PT. A first gate insulating layer GI1 may be formed on the first source/drain region SD1, the first active region ACT1 and the second source/drain region SD2. For example, the first gate insulating layer GI1 may include silicon oxide but is not limited thereto. Further, a gate GAT1 of the PMOS transistor PT may be formed on the first gate insulating layer (or film) GI1. For example, the gate GAT1 of the PMOS transistor PT may include a metal material such as molybdenum but is not limited thereto. A second gate insulating layer GI2 may be formed on the gate GAT1 of the PMOS transistor PT. For example, the second gate insulating layer GI2 may include silicon nitride but is not limited thereto.

Further, the bottom gate BML of the NMOS transistor NT may be formed on the second gate insulating (or film) GI2. For example, the bottom gate BML may include a metal material such as molybdenum but is not limited thereto. In some embodiments, the low gate voltage VGL may be applied to the bottom gate BML of the NMOS transistor NT as illustrated in FIGS. 15 and 17, or a bias voltage VBIAS may be applied to the bottom gate BML of the NMOS transistor NT as illustrated in FIGS. 12 and 13. The bias voltage VBIAS applied to the bottom gate BML may serve as a body bias voltage of the NMOS transistor NT, and a threshold voltage of the NMOS transistor NT may be adjusted by adjusting the bias voltage VBIAS. In some embodiments, the bias voltage VBIAS applied to the bottom gate BML may be lower than the low gate voltage VGL, and thus the threshold voltage of the NMOS transistor NT may be increased. In this case, a leakage current flowing through the NMOS transistor NT may be reduced. A first inter-insulating layer (or film) ILD1 may be formed on the bottom gate BML. For example, the first inter-insulating layer ILD1 may include silicon oxide or silicon nitride but is not limited thereto.

A third source/drain region SD3, the second active region ACT2 and a fourth source/drain region SD4 of the NMOS transistor NT may be formed on the first inter-insulating layer ILD1. The second active region ACT2 of the NMOS transistor NT may include a material different from the material of the first active region ACT1 of the PMOS transistor PT. For example, the second active region ACT2 of the NMOS transistor NT may include an oxide semiconductor, an organic semiconductor, amorphous silicon, etc. That is, in some embodiments, the first active region ACT1 of the PMOS transistor PT may include polycrystalline silicon, and the second active region ACT2 of the NMOS transistor NT may include an oxide semiconductor, for example indium gallium zinc oxide (IGZO) semiconductor. In other embodiments, the first active region ACT1 of the PMOS transistor PT may include polycrystalline silicon, and the second active region ACT2 of the NMOS transistor NT may include an organic semiconductor. In still other embodiments, the first active region ACT1 of the PMOS transistor PT may include polycrystalline silicon, and the second active region ACT2 of the NMOS transistor NT may include amorphous silicon. Further, in some embodiments, as illustrated in FIG. 5, the first active region ACT1 of the PMOS transistor PT and the second active region ACT2 of the NMOS transistor NT may be formed in different layers located at different heights from the substrate SUB of the display panel. The third and fourth source/drain regions SD3 and SD4 may be n+ doped regions and may respectively serve as a source and a drain of the NMOS transistor NT. A third gate insulating layer (or film) GI3 may be formed on the third source/drain region SD3, the second active region ACT2 and the fourth source/drain region SD4. For example, the third gate insulating layer GI3 may include silicon nitride but is not limited thereto. Further, a gate GAT2 (e.g., the top gate) of the NMOS transistor NT may be formed on the third gate insulating layer GI3. For example, the gate GAT2 of the NMOS transistor NT may include a metal material such as molybdenum or titanium but is not limited thereto. A second inter-insulating layer (or film) ILD2 may be formed on the gate GAT2 of the NMOS transistor NT. For example, the inter-insulating layer ILD2 may include silicon oxide or silicon nitride but is not limited thereto.

The level shifting output circuit 250 in each stage 200 may further include at least one capacitor (e.g., a second capacitor C2 illustrated in FIG. 6) connected between a gate of a PMOS transistor PT (e.g., a sixth transistor T6 illustrated in FIG. 6) and a gate of an NMOS transistor NT (e.g., a seventh transistor T7 illustrated in FIG. 6). Even if contention results from the PMOS and NMOS transistors PT and NT having different mobilities, the capacitor may maintain a node (e.g., a third node Q3 of illustrated in FIG. 6) between the PMOS and NMOS transistors PT and NT at a desired voltage.

FIG. 6 is a circuit diagram illustrating a stage of a driver according to an embodiment.

Referring to FIG. 6, each stage 200 of a driver according to embodiments may include an input circuit 210, a first transistor T1, a carry circuit 230 and a level shifting output circuit 250.

The input circuit 210 may include a second transistor T2 that transfers an input signal SIN to a first node Q1 in response to a clock signal CLK. In the embodiment of FIG. 6, the second transistor T2 may include a gate for receiving the clock signal CLK, a first terminal for receiving the input signal SIN, and a second terminal connected to the first node Q1.

The carry circuit 230 may include a fourth transistor T4 that outputs a first high gate voltage VGH1 as a carry signal CR at a carry node NCR in response to a voltage of a third node Q3, and a fifth transistor T5 that outputs a low gate voltage VGL as the carry signal CR at the carry node NCR in response to a voltage of a second node Q2. In some embodiments, the fourth transistor T4 may include a gate connected to the third node Q3, a first terminal for receiving the first high gate voltage VGH1, and a second terminal connected to the carry node NCR, and the fifth transistor T5 may include a gate connected to the second node Q2, a first terminal connected to the carry node NCR, and a second terminal for receiving the low gate voltage VGL.

The level shifting output circuit 250 may include a sixth transistor T6 that provide a second high gate voltage VGH2 to the third node Q3 in response to a voltage of a fourth node Q4, a seventh transistor T7 that provides the low gate voltage VGL to the third node Q3 in response to the voltage of the second node Q2, an eighth transistor T8 that provides the second high gate voltage VGH2 to the fourth node Q4 in response to the voltage of the third node Q3, a ninth transistor T9 that provides the low gate voltage VGL to the fourth node Q4 in response to the voltage of the second node Q2, and a second capacitor C2 connected between the fourth node Q4 and the second node Q2. In some embodiments, the sixth transistor T6 may include a gate connected to the fourth node Q4, a first terminal for receiving the second high gate voltage VGH2, and a second terminal connected to the third node Q3; the seventh transistor T7 may include a gate connected to the second node Q2, a first terminal connected to the third node Q3, and a second terminal for receiving the low gate voltage VGL; the eighth transistor T8 may include a gate connected to the third node Q3, a first terminal for receiving the second high gate voltage VGH2, and a second terminal connected to the fourth node Q4; the ninth transistor T9 may include a gate connected to the second node Q2; a first terminal connected to the fourth node Q4, and a second terminal for receiving the low gate voltage VGL; and the second capacitor C2 may include a first electrode connected to the fourth node Q4, and a second electrode connected to the second node Q2.

In some embodiments, the level shifting output circuit 250 may further include a tenth transistor T10 that outputs the second high gate voltage VGH2 as an output signal OUT at an output node NOUT in response to the voltage of the third node Q3, an eleventh transistor T11 that outputs the low gate voltage VGL as the output signal OUT at the output node NOUT in response to the voltage of the second node Q2, and a third capacitor C3 connected between the output node NOUT and the second node Q2. In some embodiments, the tenth transistor T10 may include a gate connected to the third node Q3, a first terminal for receiving the second high gate voltage VGH2, and a second terminal connected to the output node NOUT; the eleventh transistor T11 may include a gate connected to the second node Q2, a first terminal connected to the output node NOUT, and a second terminal for receiving the low gate voltage VGL; and a third capacitor C3 may include a first electrode connected to the output node NOUT, and a second electrode connected to the second node Q2.

In some embodiments, as illustrated in FIG. 6, the first, second, fourth, fifth, sixth, eighth, ninth, tenth, and eleventh transistors T1, T2, T4, T5, T6, T8, T9, T10, and T11 may be PMOS transistors, and the seventh transistor T7 may be an NMOS transistor, but embodiments are not limited thereto.

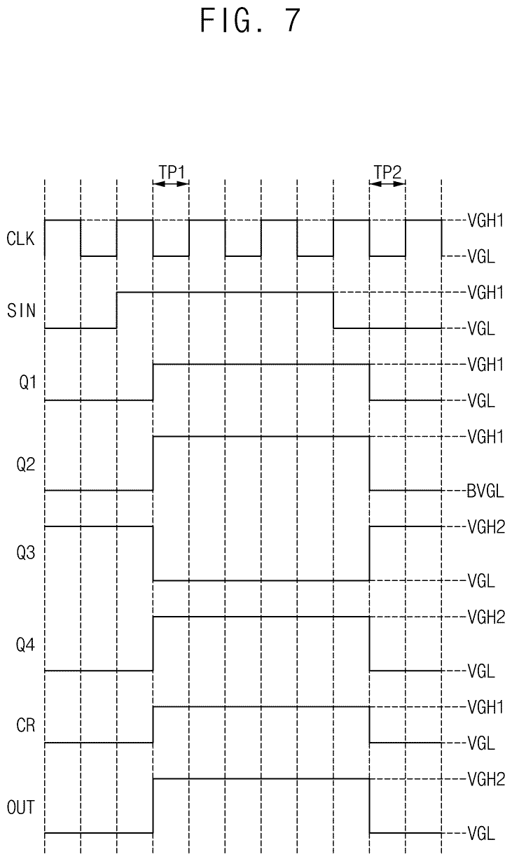

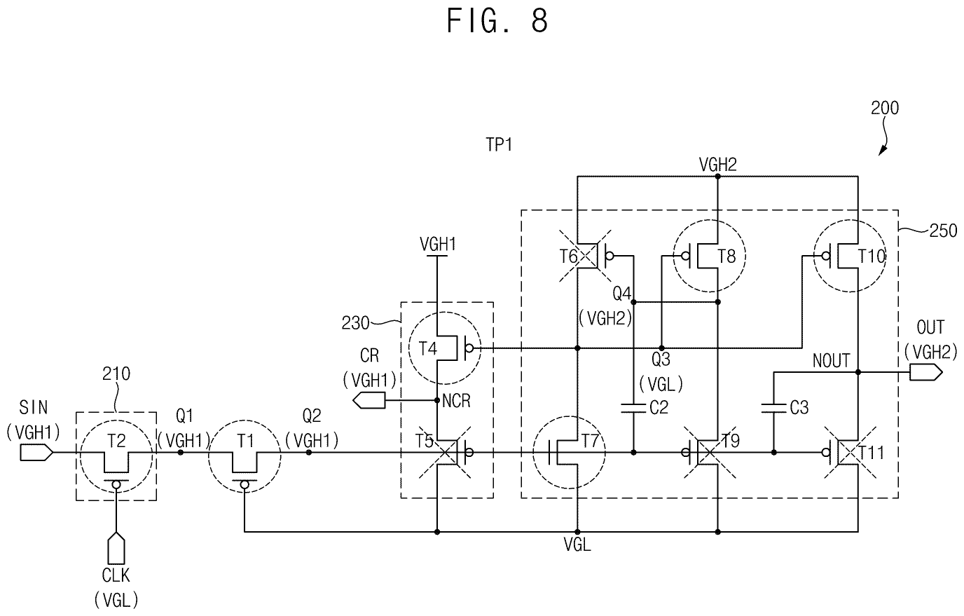

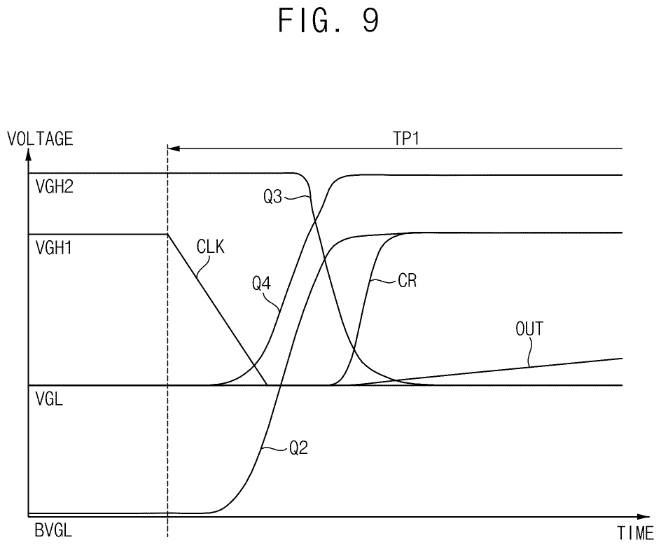

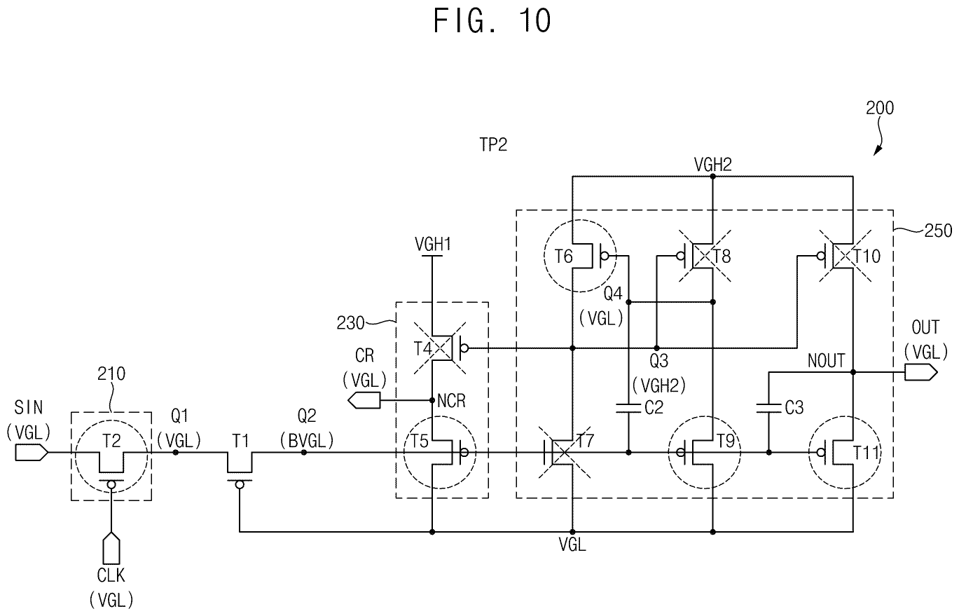

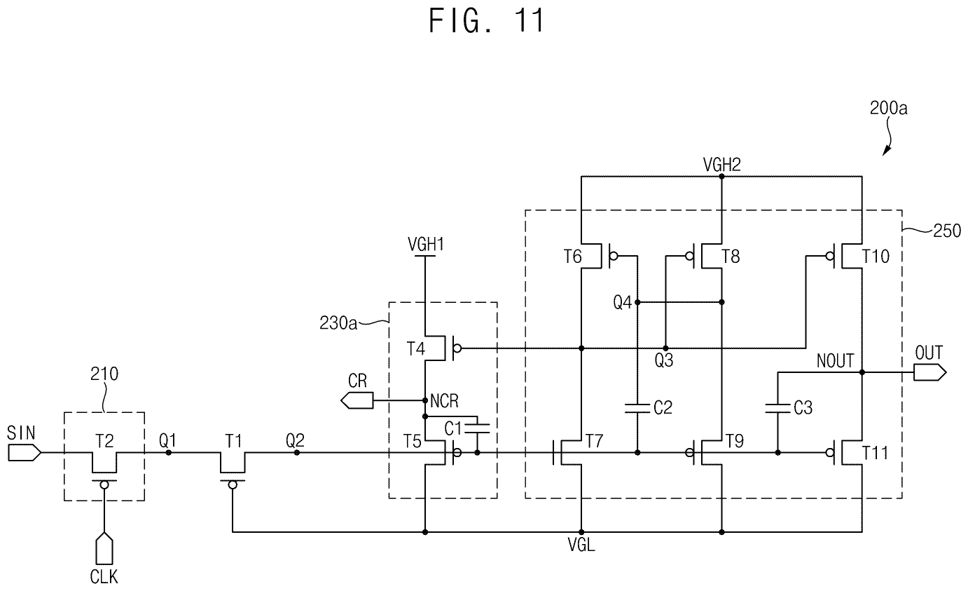

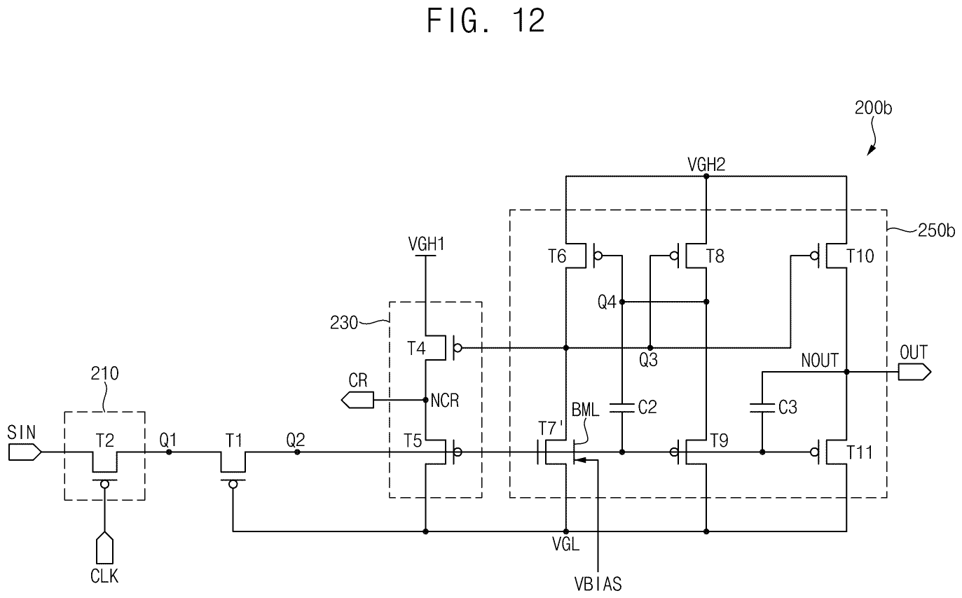

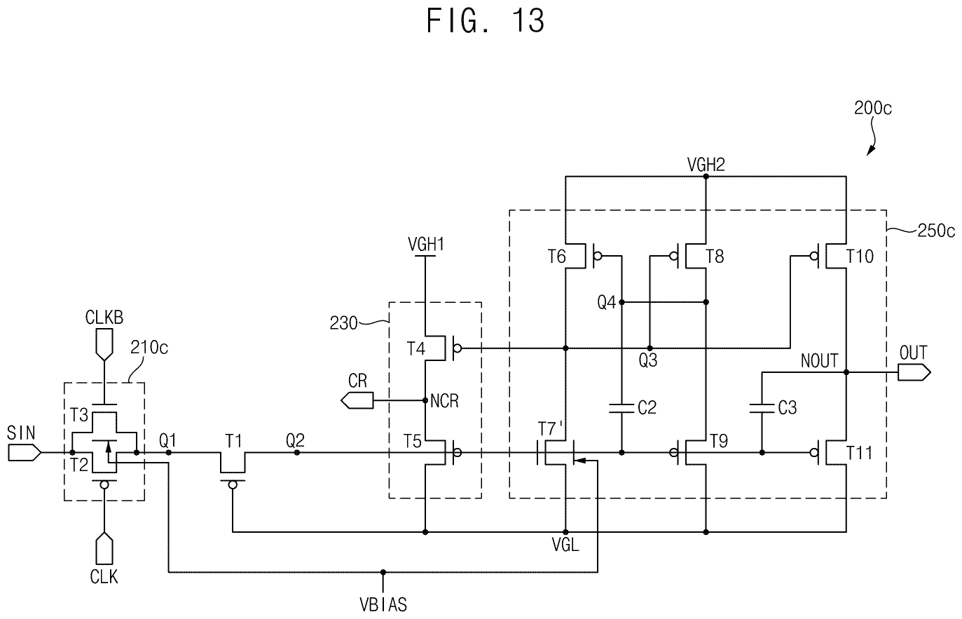

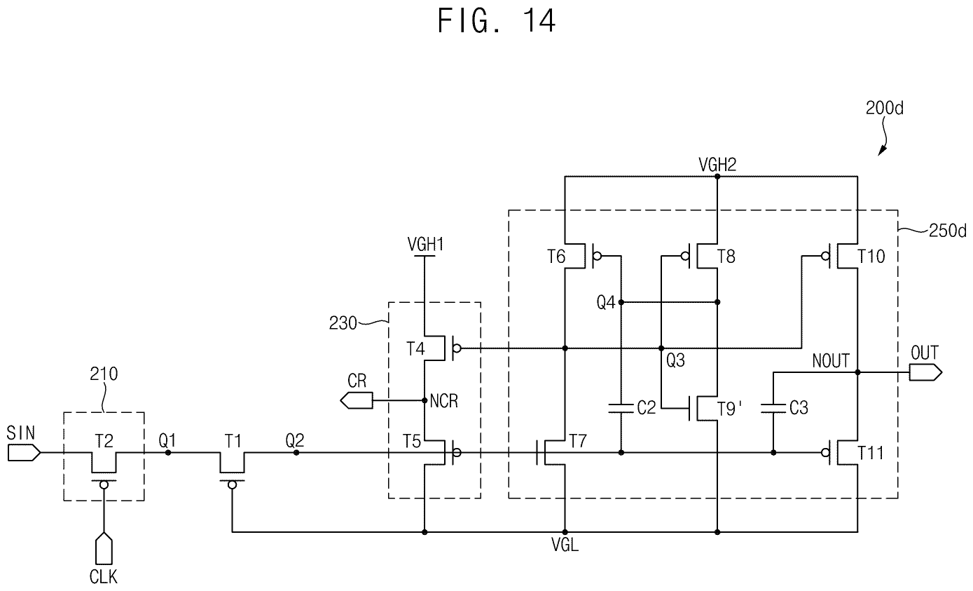

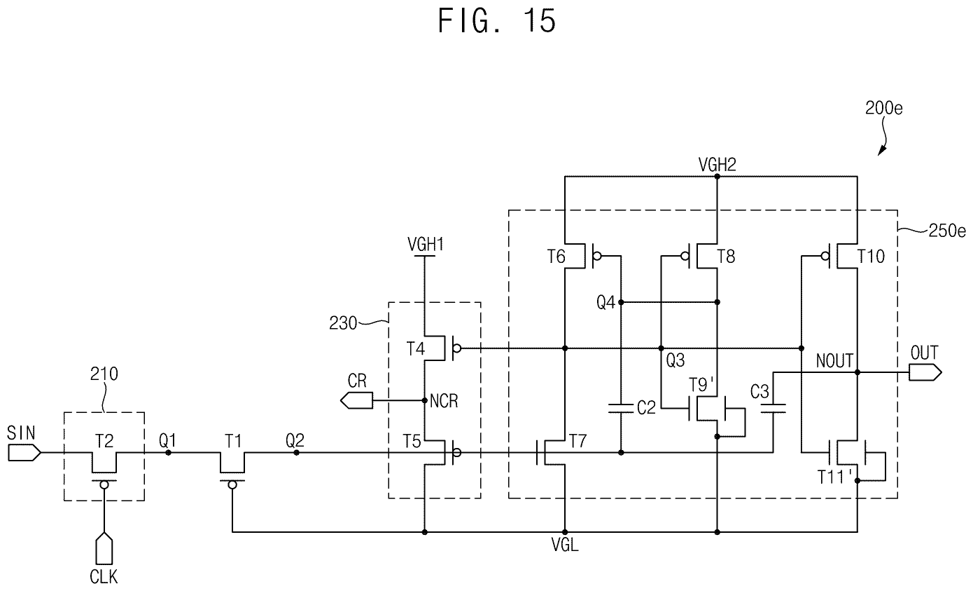

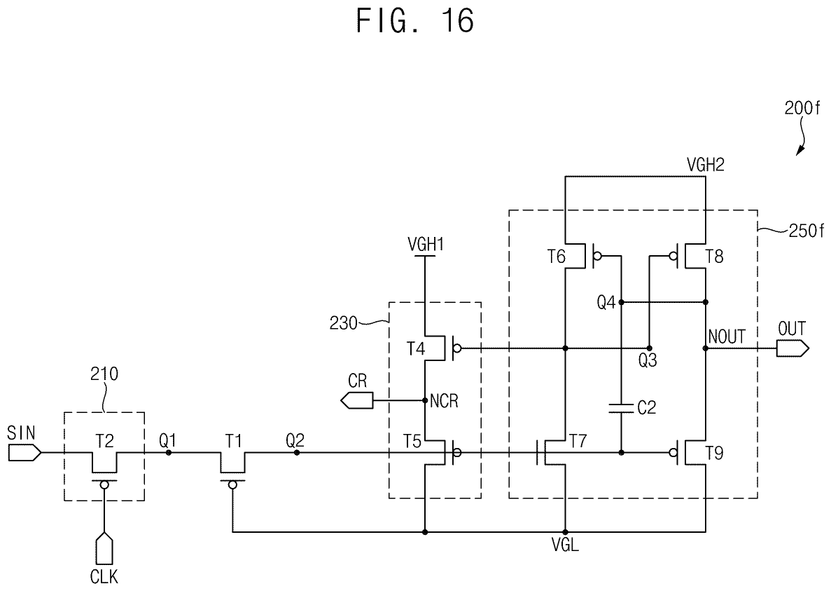

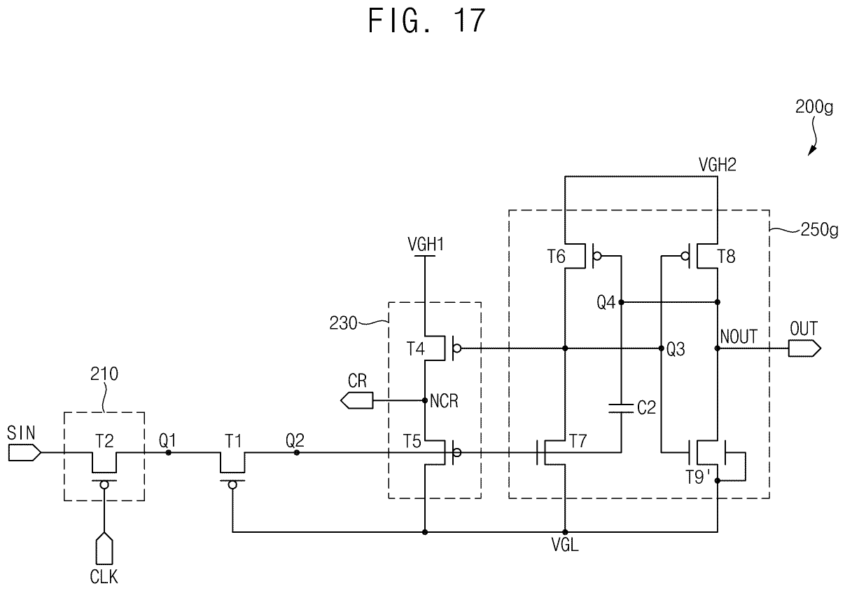

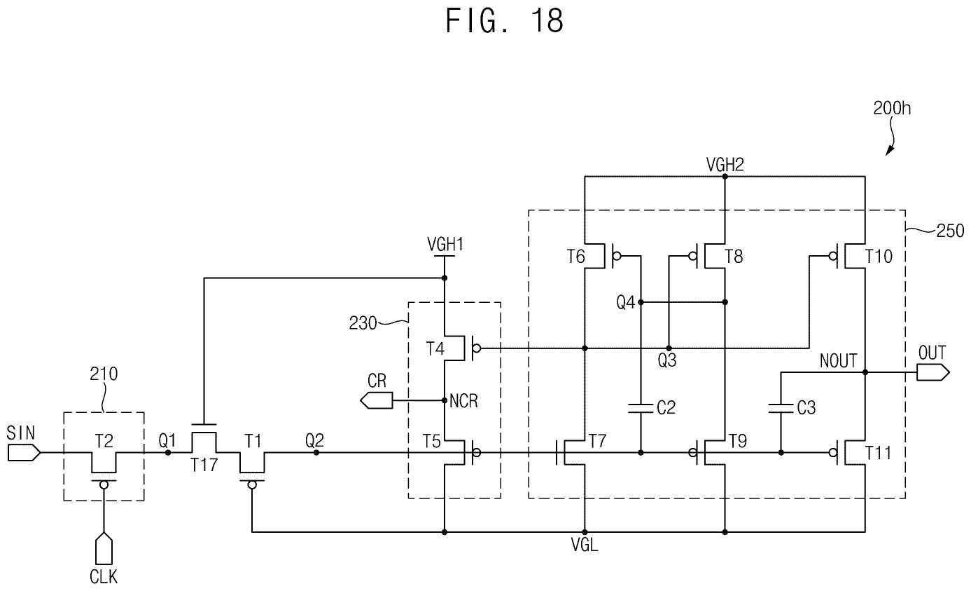

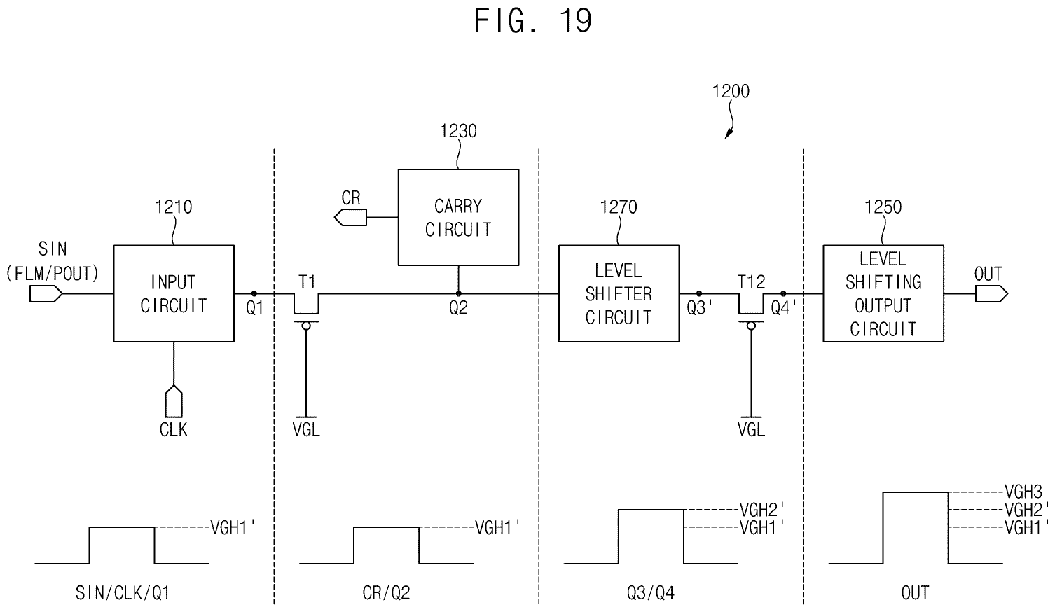

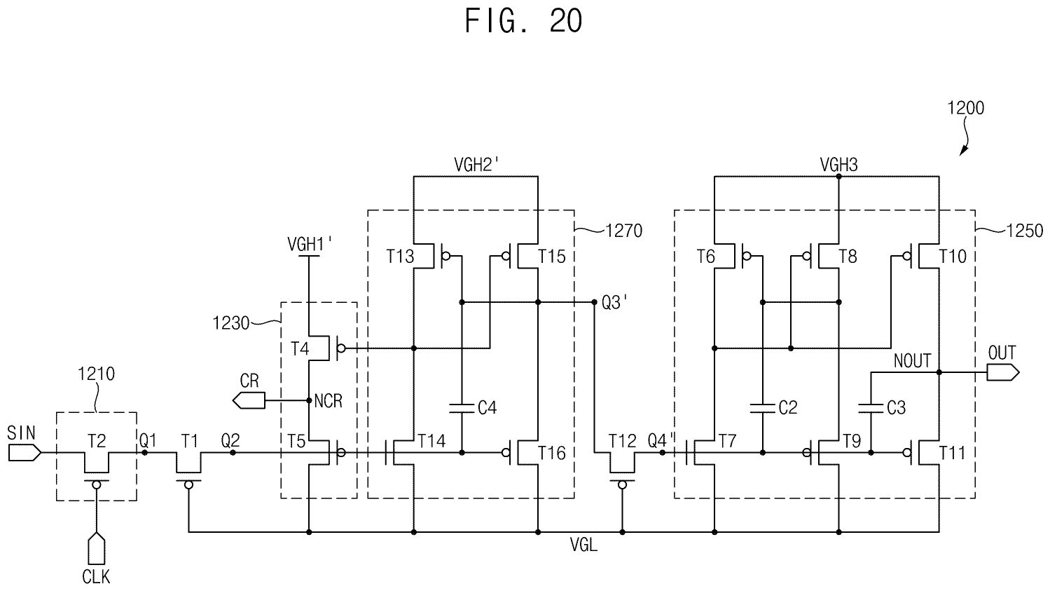

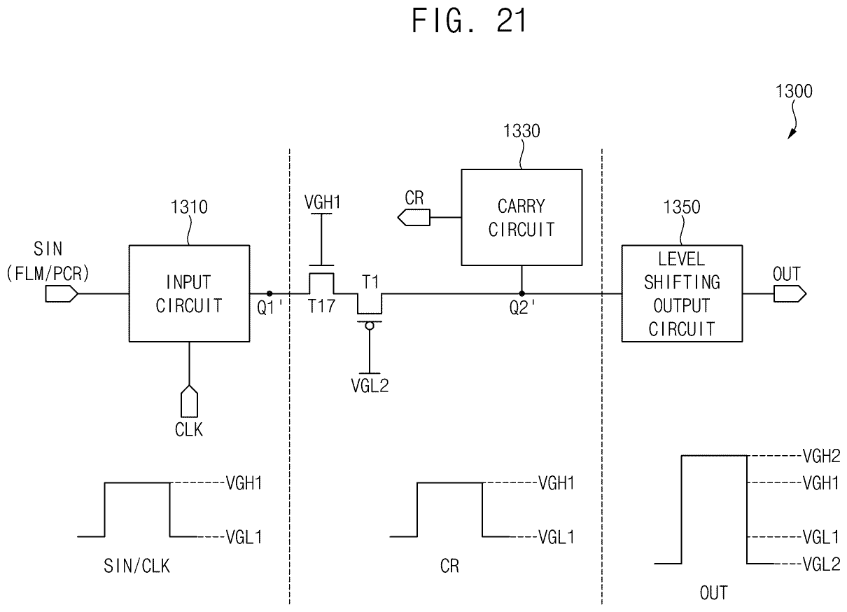

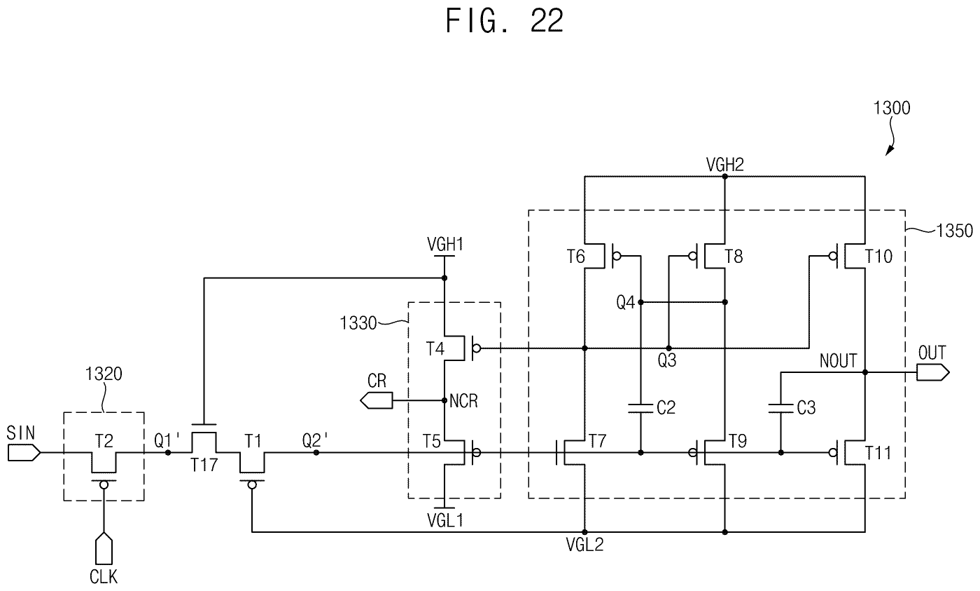

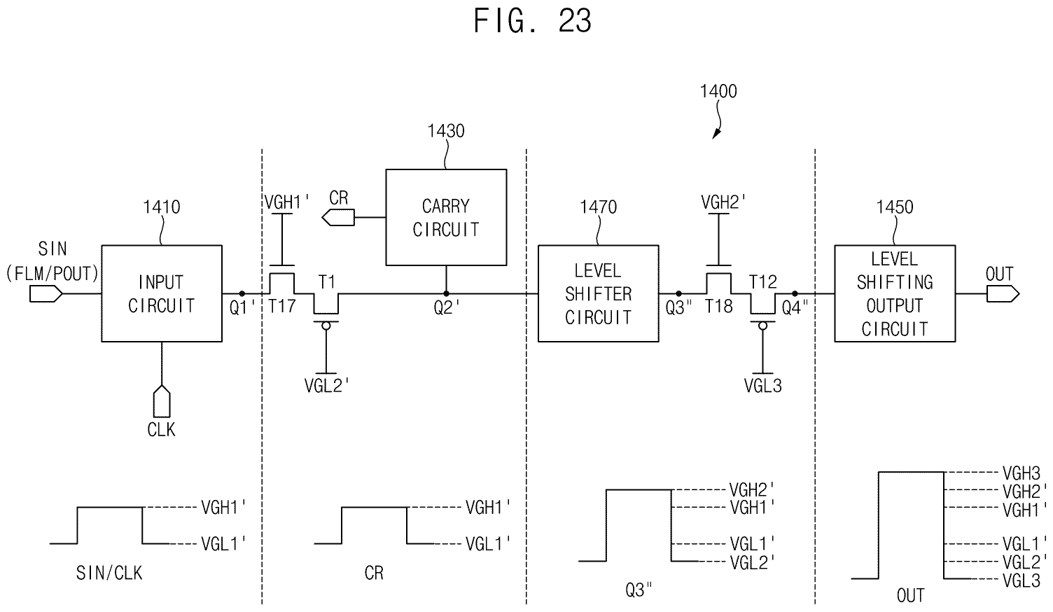

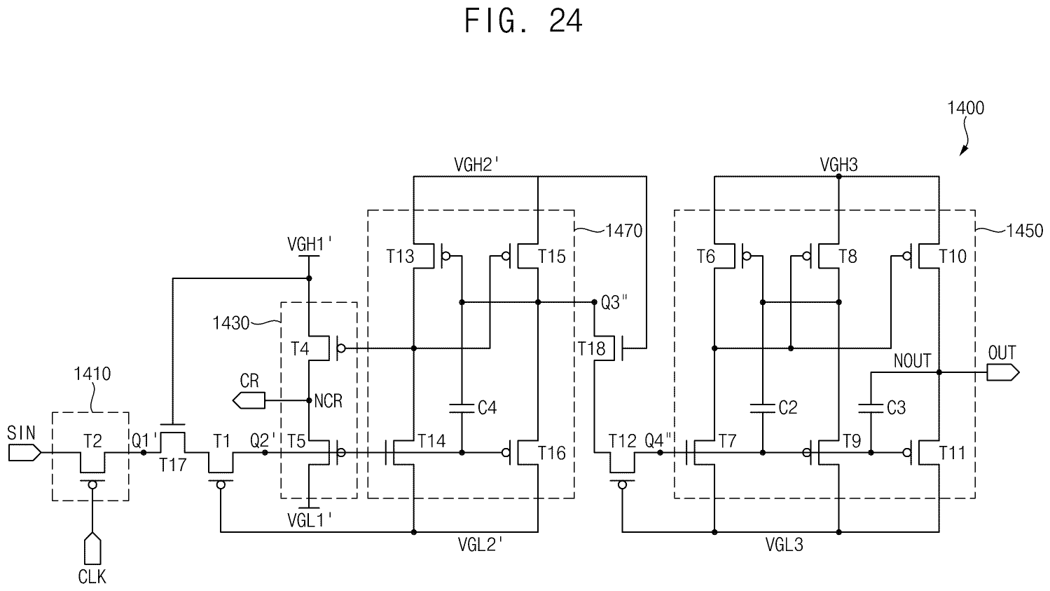

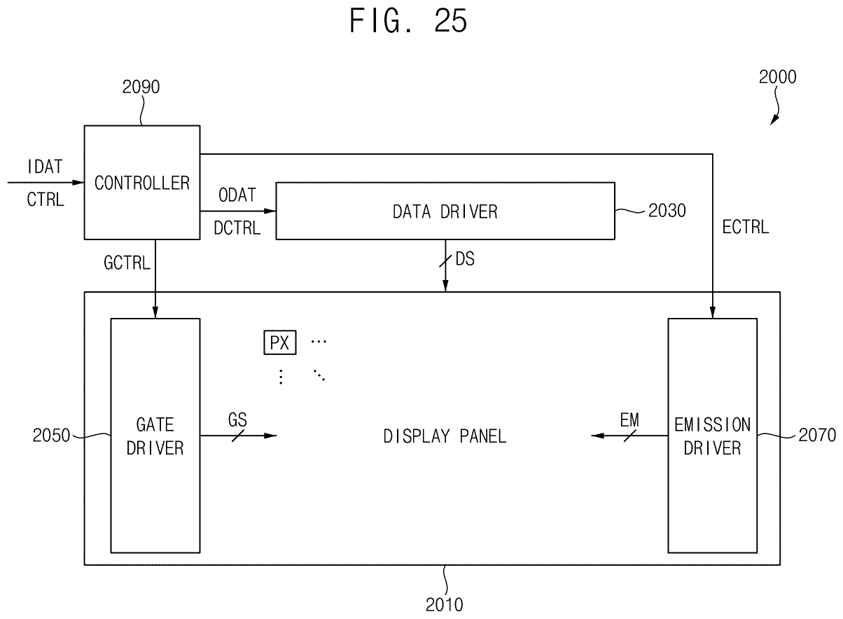

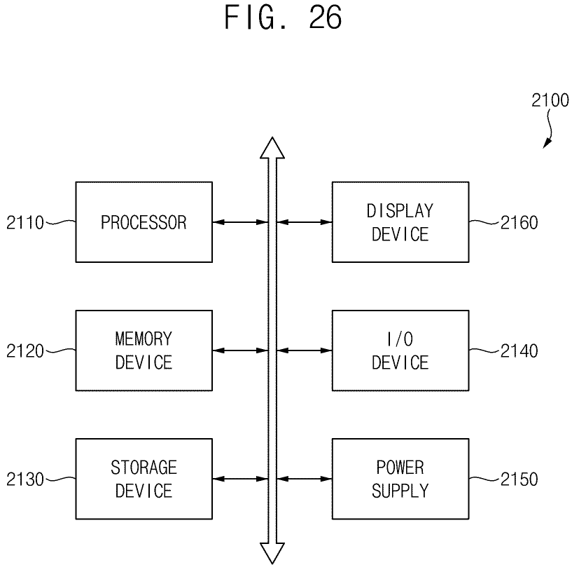

FIG. 7 is a timing diagram illustrating an example of an operation of a stage of FIG. 6, FIG. 8 is a circuit diagram illustrating an example of an operation of a stage of FIG. 6 in a first time period, FIG. 9 shows an example of signals and node voltages at a start time point of a first time period, and FIG. 10 is a circuit diagram illustrating an example of an operation of a stage of FIG. 6 in a second time period.

Referring to FIGS. 6 and 7, based on the clock signal CLK and the input signal SIN, the stage 200 may provide the carry signal CR having the first high gate voltage VGH1 to a next stage and may provide the output signal OUT having the second high gate voltage VGH2 higher than the first high gate voltage VGH1 to pixels. In some embodiments, the clock signal CLK may periodically toggle between the first high gate voltage VGH1 and the low gate voltage VGL.

In a first time period TP1 of FIG. 7, the clock signal CLK has the low gate voltage VGL after the input signal SIN becomes the first high gate voltage VGH1, and as illustrated in FIG. 8, the second transistor T2 may be turned on in response to the clock signal CLK having the low gate voltage VGL and may transfer the input signal SIN having the first high gate voltage VGH1 to the first node Q1. The first transistor T1 may be turned on in response to the low gate voltage VGL and may transfer the first high gate voltage VGH1 of the first node Q1 to the second node Q2. The fifth, ninth, and eleventh transistors T5, T9, and T11 may be turned off in response to the first high gate voltage VGH1 of the second node Q2.

The seventh transistor T7 may be turned on in response to the first high gate voltage VGH1 of the second node Q2 and may transfer the low gate voltage VGL to the third node Q3. However, since the fourth node Q4 has the low gate voltage VGL immediately before the first time period TP1, if the voltage of the fourth node Q4 does not increase, the sixth transistor T6 may prevent the seventh transistor T7 from lowering the voltage of the third node Q3 to the low gate voltage VGL. In particular, the seventh transistor T7 implemented as an oxide thin film transistor may have a driving capability lower than that of the sixth transistor T6 implemented as an LTPS thin film transistor, and thus the seventh transistor T7 may not be able to decrease the voltage of the third node Q3 to the low gate voltage VGL. However, the level shifting output circuit 250 of the stage 200 according to the illustrated embodiment may include the second capacitor C2 connected between the fourth node Q4 and the second node Q2. When the voltage of the second node Q2 increases to the first high gate voltage VGH1, the voltage of the fourth node Q4 also may increase due to capacitive coupling of the second capacitor C2. Accordingly, in the first time period TP1, the sixth transistor T6 may be turned off, and the voltage of the third node Q3 may be decreased to the low gate voltage VGL. Further, the eighth transistor T8 may be turned on in response to the low gate voltage VGL of the third node Q3 and may transfer the second high gate voltage VGH2 to the fourth node Q4.

The fourth transistor T4 may be turned on in response to the low gate voltage VGL of the third node Q3 and may output the carry signal CR having the first high gate voltage VGH1 at the carry node NCR. Further, the tenth transistor T10 may be turned on in response to the low gate voltage VGL of the third node Q3 and may output the output signal OUT having the second high gate voltage VGH2 at the output node NOUT.

FIG. 9 illustrates signals CLK, CR, and OUT and voltages on nodes Q2, Q3, and Q4 in an initial portion of the first time period TP1. As illustrated in FIG. 9, when the clock signal CLK falls to the low gate voltage VGL, the voltage of the second node Q2 may increase to the first high gate voltage VGH1. Further, when the voltage of the second node Q2 increases, the voltage of the fourth node Q4 may increase due to the capacitive coupling of the second capacitor C2. If the voltage of the second node Q2 and the voltage of the fourth node Q4 increase, the voltage of the third node Q3 may decrease to the low gate voltage VGL. If the voltage of the third node Q3 decreases, the carry signal CR may increase to the first high gate voltage VGH1, and the output signal OUT may increase to the second high gate voltage VGH2.

During a second time period TP2 shown in FIG. 7, the clock signal CLK has the low gate voltage VGL after the input signal SIN changes from the first high gate voltage VGH1 to the low gate voltage VGL. As illustrated in FIG. 10, the second transistor T2 may then be turned on in response to the clock signal CLK having the low gate voltage VGL and may transfer the input signal SIN having the low gate voltage VGL to the first node Q1. The first transistor T1 may be turned on in response to the low gate voltage VGL and may transfer the low gate voltage VGL of the first node Q1 to the second node Q2. The ninth transistor T9 may be turned on in response to the low gate voltage VGL of the second node Q2 and may transfer the low gate voltage VGL to the fourth node Q4. Thus, the voltage of the fourth node Q4 may be decreased from the second high gate voltage VGH2 to the low gate voltage VGL. If the voltage of the fourth node Q4 decreases, the capacitive coupling of the second capacitor C2 may decrease the voltage of the second node Q2 from the low gate voltage VGL to a boosted low gate voltage BVGL lower than the low gate voltage VGL. For example, in a case where the second high gate voltage VGH2 is about 7V and the low gate voltage VGL is about −7V, the boosted low gate voltage BVGL of the second node Q2 may be about −15V, but embodiments are not limited thereto. The seventh transistor T7 may be turned off in response to the boosted low gate voltage BVGL of the second node Q2. Since the boosted low gate voltage BVGL of the second node Q2 is lower than the low gate voltage VGL applied to the gate of the first transistor T1, the boosted low gate voltage BVGL of the second node Q2 may not be transferred to the first node Q1 by the first transistor T1. Further, the sixth transistor T6 may be turned on in response to the low gate voltage VGL of the fourth node Q4 and may transfer the second high gate voltage VGH2 to the third node Q3. The fourth, eighth, and tenth transistors T4, T8, and T10 may be turned off in response to the second high gate voltage VGH2 of the third node Q3.

The fifth transistor T5 may be turned on in response to the boosted low gate voltage BVGL of the second node Q2 and may output the carry signal CR having the low gate voltage VGL at the carry node NCR. Further, the eleventh transistor T11 may be turned on in response to the boosted low gate voltage BVGL of the second node Q2 and may output the output signal OUT having the low gate voltage VGL at the output node NOUT. Since the voltage of the output node NOUT decreases from the second high gate voltage VGH2 to the low gate voltage VGL, the third capacitor C3 also may play an auxiliary role in decreasing the voltage of the second node Q2 to the boosted low gate voltage BVGL lower than the low gate voltage VGL.

FIG. 11 is a circuit diagram illustrating a stage of a driver according to an embodiment.

Referring to the embodiment of FIG. 11, each stage 200a of a driver may include an input circuit 210, a first transistor T1, a carry circuit 230a, and a level shifting output circuit 250. The stage 200a of FIG. 11 may have substantially the same configuration and substantially the same operation as the stage 200 of FIG. 6, except that the carry circuit 230a further includes a first capacitor C1.

The carry circuit 230a may include the first capacitor C1 connected between a carry node NCR and a second node Q2. In some embodiments, the first capacitor C1 may include a first electrode connected to the carry node NCR and a second electrode connected to the second node Q2.

FIG. 12 is a circuit diagram illustrating a stage of a driver according to an embodiment.

Referring to the embodiment of FIG. 12, each stage 200b of a driver may include an input circuit 210, a first transistor T1, a carry circuit 230 and a level shifting output circuit 250b. The stage 200b of FIG. 12 may have substantially the same configuration and substantially the same operation as a stage 200 of FIG. 6, except that a seventh transistor T7′ in the level shifting output circuit 250b further includes a bottom gate BML.

The seventh transistor T7′ may include a gate connected to a second node Q2, a first terminal connected to a third node Q3, a second terminal for receiving a low gate voltage VGL, and the bottom gate BML. The bottom gate BML may receive the low gate voltage VGL, or a bias voltage VBIAS that is different from the low gate voltage VGL. The bias voltage VBIAS applied to the bottom gate BML may serve as a body bias voltage of the seventh transistor T7′, which is an NMOS transistor in the example of FIG. 12. A threshold voltage of the seventh transistor T7′ may be adjusted by adjusting the bias voltage VBIAS. For example, the bias voltage VBIAS applied to the bottom gate BML may be lower than the low gate voltage VGL, and thus the threshold voltage of the seventh transistor T7′ may be increased. In this case, a leakage current through the seventh transistor T7′ may be reduced, and an abnormal operation of the seventh transistor T7′ may be prevented.

FIG. 13 is a circuit diagram illustrating a stage of a driver according to an embodiment.

Referring to the embodiment of FIG. 13, each stage 200c of a driver may include an input circuit 210c, a first transistor T1, a carry circuit 230 and a level shifting output circuit 250c. The stage 200c of FIG. 13 may have substantially the same configuration and substantially the same operation as a stage 200b of FIG. 12, except that the input circuit 210c may further include a third transistor T3.

The input circuit 210c may include a second transistor T2 and the third transistor. The second transistor T2 transfers an input signal SIN to a first node Q1 in response to a clock signal CLK, and the third transistor T3 transfers the input signal SIN to the first node Q1 in response to an inverted clock signal CLKB. In some embodiments, in a case where the clock signal CLK is a first clock signal CLK1 illustrated in FIGS. 1 and 2, the inverted clock signal CLKB may be a second clock signal CLK2 illustrated in FIGS. 1 and 2. In some embodiments, the third transistor T3 may include a gate for receiving the inverted clock signal CLKB, a first terminal for receiving the input signal SIN, and a second terminal connected to the first node Q1.

Further, as illustrated in FIG. 13, the second transistor T2 may be a PMOS transistor, and the third transistor T3 may be an NMOS transistor. That is, the input circuit 210c may be implemented as a CMOS transmission gate including the PMOS transistor and the NMOS transistor connected in parallel.

In some embodiments, each of the third transistor T3 and seventh transistor T7′ that are NMOS transistors may include a gate and a bottom gate. The bottom gates may receive a low gate voltage VGL or a bias voltage VBIAS that is different from the low gate voltage VGL.

FIG. 14 is a circuit diagram illustrating a stage of a driver according to an embodiment.

Referring to the embodiment of FIG. 14, each stage 200d of a driver may include an input circuit 210, a first transistor T1, a carry circuit 230 and a level shifting output circuit 250d. The stage 200d of FIG. 14 may have substantially the same configuration and substantially the same operation as a stage 200 of FIG. 6, except that the level shifting output circuit 250d includes a ninth transistor T9′ that is implemented as an NMOS transistor and replaces the ninth transistor T9 described above.

The ninth transistor T9′ may be the NMOS transistor and may operate in response to a voltage of a third node Q3. In some embodiments, the ninth transistor T9′ may include a gate connected to the third node Q3, a first terminal connected to a fourth node Q4, and a second terminal for receiving a low gate voltage VGL.

FIG. 15 is a circuit diagram illustrating a stage of a driver according to an embodiment.

Referring to the embodiment of FIG. 15, each stage 200e of a driver may include an input circuit 210, a first transistor T1, a carry circuit 230 and a level shifting output circuit 250e. The stage 200e of FIG. 15 may have substantially the same configuration and substantially the same operation as a stage 200d of FIG. 14, except that an eleventh transistor T11′ also is implemented as an NMOS transistor and replaces the eleventh transistor T11 described above.

The eleventh transistor T11′ may be an NMOS transistor and may operate in response to a voltage of a third node Q3. In some embodiments, the eleventh transistor T11′ may include a gate connected to the third node Q3, a first terminal connected to an output node NOUT, and a second terminal for receiving a low gate voltage VGL.

In some embodiments, as illustrated in FIG. 15, each of ninth and eleventh transistors T9′ and T11′ may include a bottom gate. The bottom gate of each of the ninth and eleventh transistors T9′ and T11′ may receive the low gate voltage VGL as illustrated in FIG. 15. Alternatively, the bottom gate of each of the ninth and eleventh transistors T9′ and T11′ may receive a bias voltage different from the low gate voltage VGL.

FIG. 16 is a circuit diagram illustrating a stage of a driver according to an embodiment.

Referring to the embodiment of FIG. 16, each stage 200f of a driver may include an input circuit 210, a first transistor T1, a carry circuit 230 and a level shifting output circuit 250f. The stage 200f of FIG. 16 may have substantially the same configuration and substantially the same operation as a stage 200 of FIG. 6, except that the level shifting output circuit 250f does not include a tenth transistor T10, an eleventh transistor T11, or a third capacitor C3 illustrated in FIG. 6.

In the stage 200f of FIG. 16, a fourth node Q4 may be an output node NOUT at which an output signal OUT is output, and a voltage of the fourth node Q4 may be provided to pixels as the output signal OUT. As illustrated in FIG. 7, the voltage of the fourth node Q4 may have substantially the same waveform as the output signal OUT, and thus the voltage of the fourth node Q4 may be used as the output signal OUT.

FIG. 17 is a circuit diagram illustrating a stage of a driver according to an embodiment.

Referring to the embodiment of FIG. 17, each stage 200g of a driver may include an input circuit 210, a first transistor T1, a carry circuit 230 and a level shifting output circuit 250g. The stage 200g of FIG. 17 may have substantially the same configuration and substantially the same operation as a stage 200f of FIG. 16, except that a ninth transistor T9′ in the level shifting output circuit 250g is implemented as an NMOS transistor. The ninth transistor T9′ may be an NMOS transistor and may operate in response to a voltage of a third node Q3. In some embodiments, the ninth transistor T9′ may include a bottom gate that receives a low gate voltage VGL or a bias voltage.

FIG. 18 is a circuit diagram illustrating a stage of a driver according to an embodiment.

Referring to the embodiment of FIG. 18, each stage 200h of a driver may include an input circuit 210, a first transistor T1, a carry circuit 230, a level shifting output circuit 250, and a seventeenth transistor T17. The stage 200h of FIG. 18 may have substantially the same configuration and substantially the same operation as a stage 200 of FIG. 6, except that the stage 200h may further includes the seventeenth transistor T17 connected in series with a first transistor T1 between a first node Q1 and a second node Q2.

The first transistor T1 may be referred to as a first AOT transistor T1, the seventeenth transistor T17 may be referred to as a second AOT transistor T17, and the first and second AOT transistors T1 and T17 may be different types of transistors. For example, as illustrated in FIG. 18, the first AOT transistor T1 may be a PMOS transistor, and the second AOT transistor T17 may be an NMOS transistor. Further, for example, the first AOT transistor T1 may include a gate for receiving a low gate voltage VGL, a first terminal connected to the second AOT transistor T17, and a second terminal connected to the second node Q2, and the second AOT transistor T17 may include a gate for receiving a first high gate voltage VGH1, a first terminal connected to the first node Q1, and a second terminal connected to the first AOT transistor T1.

FIG. 19 is a block diagram illustrating a stage of a driver according to an embodiment.

Referring to the embodiment of FIG. 19, each stage 1200 of a driver may include an input circuit 1210, a first transistor T1 (or a first AOT transistor T1), a carry circuit 1230, a level shifter circuit 1270, a transistor T12 (or a second AOT transistor T12) and a level shifting output circuit 1250. The stage 1200 of FIG. 19 may have a similar configuration and a similar operation to a stage 200 of FIG. 3, except that the stage 1200 may further include the level shifter circuit 1270 and the second AOT transistor T12 between a second node Q2 and the level shifting output circuit 1250.

The input circuit 1210 may transfer an input signal SIN to a first node Q1 in response to a clock signal CLK. The first AOT transistor T1 may be connected between the first node Q1 and the second node Q2. The carry circuit 1230 may output a carry signal CR having a first high gate voltage VGH1′ when the second node Q2 has the first high gate voltage VGH1′.

The level shifter circuit 1270 may level-shift the first high gate voltage VGH1′ of the second node Q2 such that a third node Q3′ may have a second high gate voltage VGH2′ higher than the first high gate voltage VGH1′.

The second AOT transistor T12 may be connected between the third node Q3′ and a fourth node Q4′. A gate of the second AOT transistor T12 may be connected to a line for transferring the low gate voltage VGL. The second AOT transistor T12 may transfer the second high gate voltage VGH2′ of the third node Q3′ to the fourth node Q4′. In some embodiments, the second AOT transistor T12 may include a gate for receiving the low gate voltage VGL, a first terminal connected to the third node Q3′, and a second terminal connected to the fourth node Q4′.

The level shifting output circuit 1250 may output an output signal OUT having a third high gate voltage VGH3 higher than the second high gate voltage VGH2′ by level-shifting the second high gate voltage VGH2′ of the fourth node Q4′.

In the embodiment of FIG. 19, the input signal SIN, the clock signal CLK, the carry signal CR, the first node Q1 and the second node Q2 may have the first high gate voltage VGH1′ as a high voltage. The level shifter circuit 1270 may cause the third node Q3′ and the fourth node Q4′ to have the second high gate voltage VGH2′, which is higher than the first high gate voltage VGH1′, as a high voltage. In addition, the level shifting output circuit 1250 may cause the output signal OUT to have the third high gate voltage VGH3, which higher than the second high gate voltage VGH2′, as a high voltage. That is, the second high gate voltage VGH2′ may be lower than the third high gate voltage VGH3, and the first high gate voltage VGH1′ may be lower than the second high gate voltage VGH2′. Thus, the first high gate voltage VGH1′ of the input signal SIN and the clock signal CLK applied to the stage 1200 may be lower than the third high gate voltage VGH3 required by pixels to which the output signal OUT is applied, and thus power consumption of the driver including the stage 1200 may be reduced. Further, use of the level shifter circuit 1270 may allow the first high gate voltage VGH1′ of the stage 1200 of FIG. 19 to be lower than a first high gate voltage VGH1 of a stage 200 of FIG. 3, and thus the power consumption of the driver including the stage 1200 may be further reduced.

FIG. 20 is a circuit diagram illustrating a stage of a driver according to an embodiment.

Referring to the embodiment of FIG. 20, each stage 1200 of a driver may include an input circuit 1210, a first AOT transistor T1, a carry circuit 1230, a level shifter circuit 1270, a second AOT transistor T12, and a level shifting output circuit 1250. The stage 1200 of FIG. 20 may have a similar configuration and a similar operation to a stage 200 of FIG. 6, except that the stage 1200 may further include the level shifter circuit 1270 and the second AOT transistor T12 between a second node Q2 and the level shifting output circuit 1250.

The level shifter circuit 1270 may include a thirteenth transistor T13, a fourteenth transistor T14, a fifteenth transistor T15, a sixteenth transistor T16, and a fourth capacitor C4. The thirteenth transistor T13, the fourteenth transistor T14, the fifteenth transistor T15, the sixteenth transistor T16, and the fourth capacitor C4 may respectively operate to perform a level shift in the same manner that a sixth transistor T6, a seventh transistor T7, an eighth transistor T8, a ninth transistor T9, and a second capacitor C2 operate to perform a level shift as described above. For example, the thirteenth transistor T13 and the fourteenth transistor T14 may be connected in series between a line for transferring a second high gate voltage VGH2′ and a line for transferring a low gate voltage VGL, and the fifteenth transistor T15 and the sixteenth transistor T16 may be connected in series between the line for transferring the second high gate voltage VGH2′ and the line for transferring the low gate voltage VGL, and the fourth capacitor C4 may be connected between the second node Q2 and a third node Q3′.

FIG. 21 is a block diagram illustrating a stage of a driver according to an embodiment, and FIG. 22 is an example circuit diagram illustrating a stage of a driver according to the embodiment of FIG. 21.

Referring to the embodiment of FIGS. 21 and 22, each stage 1300 of a driver may include an input circuit 1310, a first transistor T1 (or a first AOT transistor T1), a transistor T17 (or a second AOT transistor T17), a carry circuit 1330, and a level shifting output circuit 1350. The stage 1300 of FIGS. 21 and 22 may have a similar configuration and a similar operation to a stage 200 of FIGS. 3 and 6, except that the stage 1300 may further include the second AOT transistor T17 connected in series with the first AOT transistor T1 between a first node Q1′ and a second node Q2′.

The first and second AOT transistors T1 and T17 may be connected in series between the first node Q1′ and the second node Q2′ and may be different types of transistors. For example, as illustrated in FIGS. 21 and 22, the first AOT transistor T1 may be a PMOS transistor, and the second AOT transistor T17 may be an NMOS transistor. Further, a gate of the first AOT transistor T1 may receive a second low gate voltage VGL2, and a gate of the second AOT transistor T17 may receive a first high gate voltage VGH1. Even if a low voltage of the second node Q2′ is boosted, the first AOT transistor T1 may prevent the boosted low voltage of the second node Q2′ from being transferred to the first node Q1′. Further, even if a high voltage of the second node Q2′ is boosted, the second AOT transistor T17 may prevent the boosted high voltage of the second node Q2′ from being transferred to the first node Q1′.

In each stage 1300 of the driver according to an embodiment, an input signal SIN, a clock signal CLK, and a carry signal CR may have the first high gate voltage VGH1 as a high voltage, and a first low gate voltage VGL1 as a low voltage. Further, the level shifting output circuit 1350 may cause an output signal OUT to have a second high gate voltage VGH2, which is higher than the first high gate voltage VGH1, as a high voltage and have the second low gate voltage VGL2, which is lower than the first low gate voltage VGL1, as a low voltage. That is, the first high gate voltage VGH1 of the input signal SIN and the clock signal CLK applied to the stage 1300 may be lower than the second high gate voltage VGH2 required by pixels to which the output signal OUT is applied, and the first low gate voltage VGL1 of the input signal SIN and the clock signal CLK applied to the stage 1300 may be higher (or less negative) than the second low gate voltage VGL2 required by the pixels to which the output signal OUT is applied. Accordingly, power consumption of the driver including the stage 1300 may be further reduced.

FIG. 23 is a block diagram illustrating a stage of a driver according to an embodiment, and FIG. 24 is an example circuit diagram illustrating a stage of a driver according to the embodiment of FIG. 23.

Referring to the embodiment of FIGS. 23 and 24, each stage 1400 of a driver may include an input circuit 1410, a first transistor T1 (or a first AOT transistor T1), a transistor T17 (or a third AOT transistor T17), a carry circuit 1430, a level shifter circuit 1470, a transistor T12 (or a second AOT transistor T12), a transistor T18 (or a fourth AOT transistor T18), and a level shifting output circuit 1450. The stage 1400 of FIGS. 23 and 24 may have a similar configuration and a similar operation to a stage 1200 of FIGS. 19 and 20, except that the stage 1400 may further includes the third AOT transistor T17 connected in series with the first AOT transistor T1 between a first node Q1′ and a second node Q2′, and the fourth AOT transistor T18 connected in series with the second AOT transistor T12 between a third node Q3″ and a fourth node Q4″.

The first and third AOT transistors T1 and T17 may be connected in series between the first node Q1′ and the second node Q2′ and may be different types of transistors. Further, the second and fourth AOT transistors T12 and T18 may be connected in series between the third node Q3″ and the fourth node Q4″ and may be different types of transistors. For example, as illustrated in FIGS. 23 and 24, the first AOT transistor T1 may be a PMOS transistor, and the third AOT transistor T17 may be an NMOS transistor. A gate of the first AOT transistor T1 may receive a second low gate voltage VGL2′, and a gate of the third AOT transistor T17 may receive a first high gate voltage VGH1′. Further, the second AOT transistor T12 may be a PMOS transistor, and the fourth AOT transistor T18 may be an NMOS transistor. A gate of the second AOT transistor T12 may receive a third low gate voltage VGL3, and a gate of the fourth AOT transistor T18 may receive a second high gate voltage VGH2′.

In each stage 1400 of the driver according to still other embodiments of the present invention, an input signal SIN, a clock signal CLK, and a carry signal CR may have the first high gate voltage VGH1′ as a high voltage and have a first low gate voltage VGL1′ as a low voltage. Further, the level shifter circuit 1470 may cause the third node Q3″ to have the second high gate voltage VGH2′, which is higher than the first high gate voltage VGH1′, as a high voltage and have the second low gate voltage VGL2′, which lower than the first low gate voltage VGL1′, as a low voltage. In addition, the level shifting output circuit 1450 may cause the output signal OUT to have a third high gate voltage VGH3, which is higher than the second high gate voltage VGH2′, as a high voltage and have the third low gate voltage VGL3, which is lower than the second low gate voltage VGL2′, as a low voltage. Accordingly, power consumption of the driver including the stage 1400 may be further reduced.

Although not illustrated in FIGS. 23 and 24, each stage 1400 may output a voltage of the third node Q3″ as an additional output signal having a voltage level different from that of the output signal OUT. In this case, each stage 1400 may further include a buffer that outputs the voltage of the third node Q3″.

FIG. 25 is a block diagram illustrating a display device according to an embodiment.

Referring to FIG. 25, a display device 2000 may include a display panel 2010 that includes a plurality of pixels PX, a data driver 2030 that provides data signals DS to the plurality of pixels PX, a gate driver 2050 that provides gate signals GS to the plurality of pixels PX, an emission driver 2070 that provides emission signals EM to the plurality of pixels PX, and a controller 2090 that controls the data driver 2030, the gate driver 2050 and the emission driver 2070.

The display panel 2010 may include data lines, gate lines, emission lines, and the plurality of pixels PX connected thereto. In some embodiments, each pixel PX may include a light emitting element, and the display panel 2010 may be a light emitting display panel. In some embodiments, the light emitting element may be an organic light emitting diode (OLED). In other embodiments, the light emitting element may be a nano light emitting diode (NED), a quantum dot (QD) light emitting diode, a micro light emitting diode, an inorganic light emitting diode, or any other suitable light emitting element. In other embodiments, the display panel 2010 may be a liquid crystal display (LCD) panel, or any other suitable display panel.

The data driver 2030 may generate the data signals DS based on a data control signal DCTRL and output image data ODAT received from the controller 2090, and the data driver 2030 may provide the data signals DS to the plurality of pixels PX through the data lines. In some embodiments, the data control signal DCTRL may include, but is not limited to, an output data enable signal, a horizontal start signal, and a load signal. In some embodiments, the data driver 2030 and the controller 2090 may be implemented as a single integrated circuit, and the single integrated circuit may be referred to as a timing controller embedded data driver (TED) integrated circuit. In other embodiments, the data driver 2030 and the controller 2090 may be implemented as separate integrated circuits.

The gate driver 2050 may generate the gate signals GS based on a gate control signals GCTRL received from the controller 2090, and the gate driver 2050 may sequentially provide the gate signals GS to the plurality of pixels PX through the gate lines on a row-by-row basis. In some embodiments, the gate signal GS applied to each pixel PX may include, but is not limited to, a compensation signal, a writing signal and/or an initialization signal. In some embodiments, the gate control signal GCTRL may include, but is not limited to, a gate start signal and a gate clock signal. In some embodiments, the gate driver 2050 may include a plurality of stages, and each stage may be a stage 200 of FIGS. 3 and 6, a stage 200a of FIG. 11, a stage 200b of FIG. 12, a stage 200c of FIG. 13, a stage 200d of FIG. 14, a stage 200e of FIG. 15, a stage 200f of FIG. 16, a stage 200g of FIG. 17, a stage 200h of FIG. 18, a stage 1200 of FIGS. 19 and 20, a stage 1300 of FIGS. 21 and 22, or a stage 1400 of FIGS. 23 and 24. Further, in some embodiments, as illustrated in FIG. 25, the gate driver 2050 may be integrated or formed in the display panel 2010. In other embodiments, the gate driver 2050 may be implemented as one or more integrated circuits.

The emission driver 2070 may generate the emission signals EM based on an emission control signal ECTRL received from the controller 2090, and the emission driver 2070 may sequentially provide the emission signals EM to the plurality of pixels PX through the emission lines on a row-by-row basis. In some embodiments, the emission control signal ECTRL may include, but is not limited to, an emission start signal and an emission clock signal. In some embodiments, the emission driver 2070 may include a plurality of stages, and each stage may be a stage 200 of FIGS. 3 and 6, a stage 200a of FIG. 11, a stage 200b of FIG. 12, a stage 200c of FIG. 13, a stage 200d of FIG. 14, a stage 200e of FIG. 15, a stage 200f of FIG. 16, a stage 200g of FIG. 17, a stage 200h of FIG. 18, a stage 1200 of FIGS. 19 and 20, a stage 1300 of FIGS. 21 and 22, or a stage 1400 of FIGS. 23 and 24. Further, in some embodiments, as illustrated in FIG. 25, the emission driver 2070 may be integrated or formed in the display panel 2010. In other embodiments, the emission driver 2070 may be implemented as one or more integrated circuits.

The controller 2090 (e.g., a timing controller (TCON)) may receive input image data IDAT and a control signal CTRL from an external host processor, e.g., a graphics processing unit (GPU), an application processor (AP) or a graphics card. In some embodiments, the input image data IDAT may be RGB image data including red image data, green image data and blue image data. In some embodiments, the control signal CTRL may include, but is not limited to, a vertical synchronization signal, a horizontal synchronization signal, an input data enable signal, a master clock signal, etc. The controller 2090 may generate the output image data ODAT, the data control signal DCTRL, the gate control signal GCTRL, and the emission control signal ECTRL based on the input image data IDAT and the control signal CTRL. The controller 2090 may control an operation of the data driver 2030 by providing the output image data ODAT and the data control signal DCTRL to the data driver 2030, may control an operation of the gate driver 2050 by providing the gate control signal GCTRL to the gate driver 2050, and may control an operation of the emission driver 2070 by providing the emission control signal ECTRL to the emission driver 2070.

In the display device 2000 according to the illustrated embodiment, at least one driver of the gate driver 2050 and the emission driver 2070 may be implemented as a driver 100 of FIG. 1. At least one stage of the driver may include a level shifting output circuit, and the level shifting output circuit may output an output signal having a second high gate voltage higher than a first high gate voltage by level-shifting the first high gate voltage of an internal node of the stage. Accordingly, the first high gate voltage of a signal applied to the stage and the first high gate voltage of the internal node of the stage may be lower than the second high gate voltage of the output signal, and thus power consumption of the driver and the display device 2000 may be reduced.

FIG. 26 is a block diagram illustrating an electronic device including a display device according to an embodiment.

Referring to FIG. 26, an electronic device 2100 may include a processor 2110, a memory device 2120, a storage device 2130, an input/output (I/O) device 2140, a power supply 2150, and a display device 2160. The electronic device 2100 may further include a plurality of ports for communicating with a video card, a sound card, a memory card, a universal serial bus (USB) device, other electric devices, etc.

The processor 2110 may perform various computing functions or tasks. The processor 2110 may be an application processor (AP), a micro processor, a central processing unit (CPU), etc. The processor 2110 may be connected to other components via an address bus, a control bus, a data bus, etc. Further, in some embodiments, the processor 2110 may be further connected to an extended bus such as a peripheral component interconnection (PCI) bus.

The memory device 2120 may store data for operations of the electronic device 2100. For example, the memory device 2120 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. and/or at least one volatile memory device such as a dynamic random access memory (DRAM) device, a static random access memory (SRAM) device, a mobile dynamic random access memory (mobile DRAM) device, etc.

The storage device 2130 may be a solid-state drive (SSD) device, a hard disk drive (HDD) device, a CD-ROM device, etc. The I/O device 2140 may be an input device such as a keyboard, a keypad, a mouse, a touch screen, etc., and an output device such as a printer, a speaker, etc. The power supply 2150 may supply power for operations of the electronic device 2100. The display device 2160 may be connected to other components through the buses or other communication links.

In the display device 2160, at least one stage of a driver may include a level shifting output circuit, and the level shifting output circuit may output an output signal having a second high gate voltage higher than a first high gate voltage by level-shifting the first high gate voltage of an internal node of the stage. Accordingly, the first high gate voltage of a signal applied to the stage and the first high gate voltage of the internal node of the stage may be lower than the second high gate voltage of the output signal, and thus power consumption of the driver and the display device 2160 may be reduced.

The concepts disclosed herein may be applied to any display device 2160 and any electronic device 2100 including the display device 2160. For example, the concepts disclosed herein may be applied to a smart phone, a wearable electronic device, a mobile phone, a television (TV) (such as a digital TV, a three dimensional (3D) TV), a personal computer (PC) (such as a tablet computer, a laptop computer), a home appliance, a personal digital assistant (PDA), a portable multimedia player (PMP), a digital camera, a music player, a portable game console, a navigation device, etc.

The foregoing is illustrative of some specific embodiments and is not to be construed as limiting thereof. Although a few embodiments have been described, those skilled in the art will readily appreciate that many modifications are possible in the embodiments without materially departing from the novel teachings and advantages of the present disclosure. Accordingly, all such modifications are intended to be included within the scope defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A driver including a plurality of stages, at least one stage of the plurality of stages comprising:
an input circuit configured to transfer an input signal to a first node in response to a clock signal;
a first transistor connected between the first node and a second node;
a carry circuit configured to output a carry signal having a first high gate voltage when the second node has the first high gate voltage; and
a level shifting output circuit configured to output an output signal having a second high gate voltage higher than the first high gate voltage by level-shifting the first high gate voltage of the second node.

2. The driver of claim 1, wherein the clock signal toggles between a low gate voltage and the first high gate voltage.

3. The driver of claim 1, wherein the level shifting output circuit includes at least one p-type metal-oxide-semiconductor (PMOS) transistor and at least one n-type metal-oxide-semiconductor (NMOS) transistor, and
wherein a first active region of the PMOS transistor includes a material different from a material of a second active region of the NMOS transistor.

4. The driver of claim 3, wherein the level shifting output circuit further includes at least one capacitor connected between a gate of the PMOS transistor and a gate of the NMOS transistor.

5. The driver of claim 1, wherein the first transistor includes a gate receiving a low gate voltage, a first terminal connected to the first node, and a second terminal connected to the second node.

6. The driver of claim 1, wherein the input circuit includes:
a second transistor including a gate receiving the clock signal, a first terminal receiving the input signal, and a second terminal connected to the first node.

7. The driver of claim 6, wherein the input circuit further includes:
a third transistor including a gate receiving an inverted clock signal, a first terminal receiving the input signal, and a second terminal connected to the first node,
wherein the second transistor is a PMOS transistor, and wherein the third transistor is an NMOS transistor.

8. The driver of claim 1, wherein the carry circuit includes:
a fourth transistor including a gate connected to a third node, a first terminal receiving the first high gate voltage, and a second terminal connected to a carry node at which the carry signal is output; and
a fifth transistor including a gate connected to the second node, a first terminal connected to the carry node, and a second terminal receiving a low gate voltage.

9. The driver of claim 8, wherein the carry circuit further includes:
a first capacitor including a first electrode connected to the carry node, and a second electrode connected to the second node.

10. The driver of claim 1, wherein the level shifting output circuit includes:
a sixth transistor including a gate connected to a fourth node, a first terminal receiving the second high gate voltage, and a second terminal connected to a third node;
a seventh transistor including a gate connected to the second node, a first terminal connected to the third node, and a second terminal receiving a low gate voltage;
an eighth transistor including a gate connected to the third node, a first terminal receiving the second high gate voltage, and a second terminal connected to the fourth node;
a ninth transistor including a gate connected to the second node, a first terminal connected to the fourth node, and a second terminal receiving the low gate voltage; and
a second capacitor including a first electrode connected to the fourth node, and a second electrode connected to the second node.

11. The driver of claim 10, wherein the sixth, eighth, and ninth transistors are PMOS transistors,
wherein the seventh transistor is an NMOS transistor,
wherein the seventh transistor further includes a bottom gate, and
wherein the bottom gate receives a bias voltage.

12. The driver of claim 11, wherein the fourth node is an output node at which the output signal is output.

13. The driver of claim 11, wherein the level shifting output circuit further includes:
a tenth transistor including a gate connected to the third node, a first terminal receiving the second high gate voltage, and a second terminal connected to an output node at which the output signal is output;
an eleventh transistor including a gate connected to the second node, a first terminal connected to the output node, and a second terminal receiving the low gate voltage; and
a third capacitor including a first electrode connected to the output node, and a second electrode connected to the second node.

14. The driver of claim 1, wherein the level shifting output circuit includes:
a sixth transistor including a gate connected to a fourth node, a first terminal receiving the second high gate voltage, and a second terminal connected to a third node;
a seventh transistor including a gate connected to the second node, a first terminal connected to the third node, and a second terminal receiving a low gate voltage;
an eighth transistor including a gate connected to the third node, a first terminal receiving the second high gate voltage, and a second terminal connected to the fourth node;
a ninth transistor including a gate connected to the third node, a first terminal connected to the fourth node, and a second terminal receiving the low gate voltage; and
a second capacitor including a first electrode connected to the fourth node, and a second electrode connected to the second node.

15. The driver of claim 14, wherein the level shifting output circuit further includes:
a tenth transistor including a gate connected to the third node, a first terminal receiving the second high gate voltage, and a second terminal connected to an output node at which the output signal is output;
an eleventh transistor including a gate connected to the third node, a first terminal connected to the output node, and a second terminal receiving the low gate voltage; and
a third capacitor including a first electrode connected to the output node, and a second electrode connected to the second node.

16. The driver of claim 15, wherein the sixth, eighth, and tenth transistors are PMOS transistors,
wherein the seventh, ninth, and eleventh transistors are NMOS transistors,
wherein each of the ninth and eleventh transistors further includes a bottom gate, and
wherein the bottom gate receives the low gate voltage.

17. The driver of claim 1, wherein the at least one stage further includes:
a second transistor connected in series with the first transistor between the first node and the second node,
wherein the first and second transistors are different types of transistors, and
wherein a second low gate voltage of the output signal is lower than a first low gate voltage of the input signal, the clock signal, and the carry signal.

18. A driver including a plurality of stages, at least one stage of the plurality of stages comprising:
an input circuit configured to transfer an input signal to a first node in response to a clock signal;
a first transistor connected between the first node and a second node;
a carry circuit configured to output a carry signal having a first high gate voltage when the second node has the first high gate voltage;
a level shifter circuit configured to level-shift the first high gate voltage of the second node such that a third node has a second high gate voltage higher than the first high gate voltage;
a second transistor connected between the third node and a fourth node and configured to transfer the second high gate voltage of the third node to the fourth node; and
a level-shifting output circuit configured to output an output signal having a third high gate voltage higher than the second high gate voltage by level-shifting the second high gate voltage of the fourth node.

19. The driver of claim 18, wherein the at least one stage further includes:
a third transistor connected in series with the first transistor between the first node and the second node; and
a fourth transistor connected in series with the second transistor between the third node and the fourth node,
wherein the first and third transistors are different types of transistors,
wherein the second and fourth transistors are different types of transistors,
wherein a second low gate voltage of the third node is lower than a first low gate voltage of the input signal, the clock signal, and the carry signal, and
wherein a third low gate voltage of the output signal is lower than the second low gate voltage of the third node.

20. A display device comprising:
a display panel including a plurality of pixels;
a data driver configured to provide data signals to the plurality of pixels;
a gate driver configured to provide gate signals to the plurality of pixels;
an emission driver configured to provide emission signals to the plurality of pixels; and
a controller configured to control the data driver, the gate driver, and the emission driver,
wherein at least one of the gate driver and the emission driver includes a plurality of stages, and
wherein at least one stage of the plurality of stages comprises:
an input circuit configured to transfer an input signal to a first node in response to a clock signal;
a first transistor connected between the first node and a second node;
a carry circuit configured to output a carry signal having a first high gate voltage when the second node has the first high gate voltage; and
a level shifting output circuit configured to output an output signal having a second high gate voltage higher than the first high gate voltage by level-shifting the first high gate voltage of the second node.
